(19) United States
(12) Patent Application Publication
(10) Pub. No.: US 2005/0277048 A1
(43) Pub. Date: Dec. 15, 2005

(54) Image forming apparatus, image forming method, toner and process cartridge

(76) Inventor: Masami Tomita, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/149,373

(22) Filed: Jun. 10, 2005

(30) Foreign Application Priority Data
Jun. 10, 2004 (JP) 2004-172364
Jul. 16, 2004 (JP) 2004-209838

(51) Int. Cl. G03G 9/08

(52) U.S. Cl. 430/110.3; 430/124; 430/110.4

(57) ABSTRACT

An image forming apparatus, including an image bearing member, a charging device, an irradiating device, a developing device, a cleaning device, a transfer device, and a fixing device. The fixing device includes an endless belt having an elastic layer, a plurality of rotation bodies located inside the endless belt, and a pressing rotation body located outside the endless belt. The pressing rotation body forms a nip portion with the endless belt while sandwiching the endless belt with one of the plurality of the rotation bodies to fix the toner image on the recording material. The nipping time is from 35 to 70 ms, at least one of the pressing rotation body and the rotation body has an elastic layer having a rubber hardness of from 20 to 40 Hs, and the toner has a weight average particle diameter of from 2 to 5 μm.

### BACKGROUND OF THE INVENTION

1. Field of the Invention

The present invention relates to an image forming apparatus, an image forming method, a toner and a process cartridge for use in developing images formed in electrophotographic, electrostatic recording and electrostatic printing processes performed by a photocopier, a printer, etc.

2. Discussion of the Background

A heating roller fixing system, which is simple-structured and easy to handle, is typically used as a fixing system for a photocopier, a printer, etc. However, there is a drawback in this heating roller fixing system in that the thermal capacity of a heating roller and/or a heating body is inevitably large because it is necessary to maintain a heating roller at a suitable temperature; (1) to avoid a long waiting time needing to be taken before the heating roller is heated to the suitable temperature and (2) to prevent poor fixing performance and offset phenomenon due to variance in the temperature of the heating roller caused by passing of recording materials and/or other factors.

There is also another drawback in that, when a full color toner, which typically has a low viscosity, is used, release oil is needed to be applied to a roller and an oil tank to reserve the release oil is also necessary to be provided because, (3) due to the curvature of a roller, offset may occur and a recording material may be curled and attached to the roller. To deal with these drawbacks, a belt fixing system is proposed and further another belt fixing system, in which oil is not or only a little oil is applied (i.e., oilless fixing system), is also proposed. Recently, these systems have been marketed taking into account the combination of a belt fixing system and a toner which can be used therefor as described in published unexamined Japanese Patent Applications Nos. (hereinafter referred to as JOP) H02-160259 and H02-161462.

Color printers and photocopiers are rapidly superseding monochrome printers photocopiers and printers in the market and the full-color market is especially expanding. Color toners show a color when at least two color toners are overlapped and mixed. To obtain a vivid color image with good color reproduction, the toners need to be sufficiently fused and mixed. Clarity and vividness to a color image are further added by gloss. Smoothness of a fixing surface affects gloss property. Pressing a fixing surface from upward is a means to obtain smoothness thereof. In the roller fixing system, a roller made of an elastic body having a significant thickness is typically used in the case of color toners, resulting in high pressure to a fixing surface. In contrast, in the belt fixing system, pressure to a fixing surface is not large. Therefore the pressing effect is not effective to obtain the smoothness. In such a situation, it is good to use a toner having a relatively low viscosity in terms of gloss. However, the use of such a toner tends to increase the frequency of offset occurrence. In addition, the state of the belt surface greatly affects the smoothness of a fixed image.

JOP H02-160250 discloses a toner in which its volume average particle diameter and the content of fine particles and coarse particles are specified to reduce the roughness in the surface of the toner layer. However, when the surface of a transfer material is significantly irregular, it is not guaranteed that an image is sufficiently fixed. Further, JOP H11-125948 discloses a teaching in which the surface roughness of an image on a transparent sheet is specified. However, since the surface property between a transparent sheet and a paper is different, offset and gloss properties of a paper are not relevantly improved by specifying the surface roughness of a transparent sheet.

Further JOP H07-209952, 2000-075551, etc. describe a system using an intermediate transfer device adopted for electrophotographic image forming apparatuses to obtain full-color images. When a background fouling occurs to an image bearing member in an electrophotograpic apparatus adopting the system using an intermediate transfer device during development, this system is effective to prevent direct displacement of the fouling to a recording medium. However, there are two transfer processes in the system using an intermediate transfer device, which are a transfer process from an electrostatic image bearing member to the intermediate transfer device and another transfer process from the intermediate transfer device to a transfer material on which a final image is obtained, resulting in deterioration of transfer efficiency. The quality of obtained images deteriorates especially when a toner having a particle diameter not greater than 5 μm is used.

JOP H10-232571, 2002-268400, etc. describe a technique of applying a material to the surface of an intermediate transfer device which can reduce the surface energy thereof. However, even when the transfer efficiency is improved to a level which is free from practical problems by adopting such a technique, it is found that there are still unsolved drawbacks causing cold offset, smear, etc. with regard to fixability.

For example, it is possible to extremely increase the nip pressure of a fixing device to solve the drawbacks related to fixability mentioned above. However, this solution is not preferred because of other problems such that the fixing device is increased in size to bear a high pressure, members in the fixing device tend to be abraded and worn sooner under a high pressure and passability of a transfer material deteriorates.

### SUMMARY OF THE INVENTION

Because of these reasons, the present inventor recognized that a need exists for an image bearing member having a fixing device which improves the anti-offset property and gloss property of an image obtained even on a recording medium having a significant irregular surface without causing other requirements such as the size increase in a fixing device and a high nip pressure.

Accordingly, an object of the present invention is to provide an image forming apparatus having a belt type fixing device with or without an intermediate transfer device by which quality images are obtained even on a transfer material having a relatively rough surface, i.e., a smoothness not greater than 40 sec.

A further object is to provide a toner for use in the image forming apparatus and a method of forming such quality images.

Briefly these objects and other objects of the present invention as hereinafter will become more readily apparent and can be attained by an image forming apparatus including an image bearing member, a charging device configured to charge the image bearing member, an irradiating device configured to irradiate the image bearing member to form a latent electrostatic image thereon, a developing device configured to develop the latent electrostatic image on the image bearing member with a toner, a cleaning device configured to remove residual toner remaining on the image bearing member, a transfer device configured to transfer the toner image to a recording material, and a fixing device configured to fix the toner image on the recording material. The fixing device includes an endless belt having an elastic layer on a surface thereof, a plurality of rotation bodies located inside the endless belt, at least one of which is a heating roller, a pressing rotation body located outside the endless belt and configured to form a nip portion with the endless belt while sandwiching the endless belt with one of the plurality of the rotation bodies which is placed opposite to the pressing rotation body to fix the toner image on the recording material upon application of heat. Further, the nipping time is from 35 to 70 ms, at least one of the pressing rotation body and the rotation body located opposite thereto has an elastic layer having a rubber hardness of from 20 to 40 Hs, and the toner has a weight average particle diameter of from 2 to 5 μm.

It is preferred that, in the image forming apparatus mentioned above, the surface of the pressing rotation body is covered with a material containing at least one of a fluorine resin and a silicone resin.

It is still further preferred that, in the image forming apparatus mentioned above, when both the pressing rotation body and the rotation body located opposite to the pressing body include an elastic layer, the elastic layer of the rotation body located opposite to the pressing body has a relatively small rubber hardness in comparison with that of the pressing rotation body.

It is still further preferred that, in the image forming apparatus mentioned above, the toner has a form factor SF-1 of from 110 to 150.

It is still further preferred that, in the image forming apparatus mentioned above, the fixing device further includes an electromagnetic generation device and the heating roller is formed of a magnetic metal and is heated by electromagnetic induction of the electromagnetic induction generation device.

It is still further preferred that, in the image forming apparatus mentioned above, the electromagnetic induction generation device is provided outside the heating roller with the endless belt therebetween and the heating roller is different from the rotation body located opposite to the pressing body.

It is still further preferred that, in the image forming apparatus mentioned above, the pressing rotation body has a heat source.

It is still further preferred that, in the image forming apparatus mentioned above, particulates having a number average particle diameter of from 0.04 to 0.30 μm are attached to the surface of the toner.

It is still further preferred that, in the image forming apparatus mentioned above, the toner further contains a release agent and a content thereof is 3 to 10 weight % based on a weight of the toner.

It is still further preferred that, in the image forming apparatus mentioned above, the toner is manufactured in an aqueous medium.

It is still further preferred that, in the image forming apparatus mentioned above, the image bearing member is an amorphous silicon photoreceptor.

It is still further preferred that, in the image forming apparatus mentioned above, when the latent electrostatic image is developed, an alternative electric field is applied thereto.

It is still further preferred that, in the image forming apparatus mentioned above, the charging device includes a charging member and charges the image bearing member by applying a voltage to the charging portion while the charging member is in contact with the image bearing member.

It is still further preferred that, in the image forming apparatus mentioned above, the transfer device is an intermediate transfer device configured to form full color images, to which the toner image is primarily transferred from the image bearing member and from which the transferred image is secondarily transferred to the recording material with a nip pressure of from 2 to 10 N/cm² and a nip pressure at the fixing device is from 10 to 50 N/cm².

It is still further preferred that, in the image forming apparatus mentioned above, the electrophotographic image formation processes are performed using a tandem system.

It is still further preferred that, in the image forming apparatus mentioned above, the intermediate transfer device includes a single layer containing a resin.

As another aspect of the present invention, a method of forming an image is provided and includes charging an image bearing member by a charging device, irradiating the image bearing member by an irradiating device to form a latent electrostatic image thereon, developing the latent electrostatic image on the image bearing member with a toner by a developing device, removing residual toner remaining on the image bearing member by a cleaning device, transferring the toner image to a recording material by a transfer device, and fixing the toner image on the recording material by a fixing device. The fixing device includes an endless belt having an elastic layer on the surface thereof, a plurality of rotation bodies located inside the endless belt, at least one of which is a heating roller, and a pressing rotation body located outside the endless belt and configured to form a nip portion with the endless belt while sandwiching the endless belt with one of the plurality of the rotation bodies which is placed opposite to the pressing rotation body to fix the toner image on the recording material upon-application of heat. The nipping time is from 35 to 70 ms. Further at least one of the pressing rotation body and the rotation body located opposite thereto has an elastic layer having a rubber hardness of from 20 to 40 Hs, and the toner has a weight average particle diameter of from 2 to 5 μm.

As another aspect of the present invention, a toner is provided which includes toner particles having a weight average particle diameter of from 2 to 5 μm and is used in an image forming apparatus including an image bearing member, a charging device configured to charge the image bearing member, an irradiating device configured to irradiate the image bearing member to form a latent electrostatic image thereon, a developing device configured to develop the latent electrostatic image on the image bearing member with the toner, a cleaning device configured to remove residual toner remaining on the image bearing member, a transfer device configured to transfer the toner image to a recording material and a fixing device configured to fix the toner image on the recording material. The fixing device includes an endless belt having an elastic layer on the surface thereof, a plurality of rotation bodies located inside the endless belt, at least one of which is a heating roller, a pressing rotation body located outside the endless belt and configured to form a nip portion with the endless belt while sandwiching the endless belt with one of the plurality of the rotation bodies which is placed opposite to the pressing rotation body to fix the toner image on the recording material upon application of heat. Further, the nipping time is from 35 to 70 ms, at least one of the pressing rotation body and the rotation body located opposite thereto has an elastic layer having a rubber hardness of from 20 to 40 Hs.

It is preferred that the toner has a form factor SF-1 of from 110 to 150.

It is still further preferred that particulates having a number average particle diameter of from 0.04 to 0.30 μm are attached to the surface of the toner particle.

It is still further preferred that the toner further contains a release agent and the content thereof is from 3 to 10 weight % based on the content of the toner.

It is still further preferred that the toner is manufactured in an aqueous medium.

As another aspect of the present invention, a process cartridge is provided and includes an image bearing member, at least one device selected from the group consisting of a charging device to charge the image bearing member, a developing device and a cleaning device, which is integrally supported with the image bearing member. Further, the process cartridge is detachably attached to an image forming apparatus including a charging device configured to charge the image bearing member, an irradiating device configured to irradiate the image bearing member to form a latent electrostatic image thereon, a developing device configured to develop the latent electrostatic image on the image bearing member with a toner, a cleaning device configured to remove residual toner remaining on the image bearing member, a transfer device configured to transfer the toner image to a recording material and a fixing device configured to fix the toner image on the recording material. The fixing device includes an endless belt having an elastic layer on the surface thereof, a plurality of rotation bodies located inside the endless belt, at least one of which is a heating roller, and a pressing rotation body located outside the endless belt and configured to form a nip portion with the endless belt while sandwiching the endless belt with one of the plurality of the rotation bodies which is placed opposite to the pressing rotation body to fix the toner image on the recording material upon application of heat. Further, the nipping time is from 35 to 70 ms, at least one of the pressing rotation body and the rotation body located opposite thereto has an elastic layer having a rubber hardness of from 20 to 40 Hs, and the toner has a weight average particle diameter of from 2 to 5 μm.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an embodiment of the image forming apparatus of the present invention;

FIG. 2 is a diagram illustrating an example of the fixing device for use in the image forming apparatus of the present invention;

FIG. 3 is a diagram illustrating another example of the fixing device for use in the image forming apparatus of the present invention;

FIG. 4 is a diagram illustrating an example of the layer structure of the belt for use in the fixing device for use in the image forming apparatus of the present invention;

FIG. 5 is a diagram illustrating an example of the layer structure of the intermediate transfer belt for use in the image forming apparatus of the present invention;

FIGS. 6A to 6D are diagrams illustrating an example of the layer structure of the amorphous silicon photoreceptors for use in the image forming apparatus of the present invention;

FIG. 7 is a schematic diagram illustrating an example of the developing device for use in the image forming apparatus of the present invention;

FIG. 8 is a schematic diagram illustrating an example of the contact type charging device (roller system) for use in the image forming apparatus of the present invention;

FIG. 9 is a schematic diagram illustrating the contact type charging device (brush system) for use in the image forming apparatus of the present invention; and

FIG. 10 is a diagram illustrating the process cartridge for use in the image forming apparatus of the present invention.

### DETAILED DESCRIPTION OF THE PREFERRED EMBODIMENTS

The present invention will be described below in detail with reference to several embodiments and accompanying drawings.

The present invention is an image forming apparatus and an image forming method by which sufficient fixability is obtained not only for a transfer material such as paper having a smooth surface but also for a transfer material having a rough surface, i.e., a smoothness not greater than 40 sec.

Embodiments of the present invention are typified into first case embodiments in which an image forming apparatus and a method using a belt type fixing device without an intermediate transfer device are used and second case embodiments in which a full-color image forming apparatus and a method using a belt type fixing device with an intermediate transfer device are used.

The embodiments in the first case, i.e., the embodiments of the image forming apparatus and method using a belt type fixing device without an intermediate transfer device, will be described. In addition, the embodiments in the first case and in the second case are separated only for descriptional convenience and do not limit the scope of the clams of the present invention. It is easy for one of ordinary skill in the art to make many changes and modifications without departing from the spirit and scope of embodiments of the invention to form other embodiments. Such changes and modifications are included in the scope of the present invention. The following descriptions are for illustration purposes only.

The surface properties of a transfer material can be represented by smoothness. Typically the smoothness of a plain paper for use in photocopying, printing, etc. in electrophotographic process ranges from greater than 40 sec to about 150 sec. In this range, sufficient fixability can be obtained with a typical fixing device. However, in the case of a transfer material having a rough surface, i.e., a smoothness not greater than 40 sec, the fixability is not sufficient.

Specific examples of transfer materials having a smoothness not greater than 40 sec include certain kinds of recycled papers and cotton papers but are not limited thereto.

The method of measuring the smoothness of a transfer material complies with JIS P 8119 (Paper and Board-Determination of smoothness by Bekk method).

The image forming apparatus of the present invention can include a device to detect and/or input the smoothness of a transfer material. Also the fixing conditions may be altered based on the information received from such a device. For example, when a transfer material having a relatively low smoothness is used, the nip time can be elongated.

Usually, as the particle diameter of a toner decreases, the development becomes more true to a latent electrostatic image. Therefore images having high resolution can be obtained. However, when a transfer material having a significant irregular surface is used, a toner having a small particle diameter does not tend to receive a sufficient energy, resulting in insufficient fixability. It is necessary to apply a high pressure during fixing to solve this problem. But application of a high pressure during fixing is not preferred because such a high pressure may have an impact on the life of a fixing device. Further, to solve this problem, the present inventor found that a pressing rotation body and/or a rotation body placed opposite thereto (hereinafter referred to as an opposing rotation body) preferably has an elastic layer having a rubber hardness of from 20 to 40 Hs and the nip time is from 35 to 70 ms.

It is preferred that a toner has a weight average particle diameter of from 2 to 5 μm considering the purpose of the present invention. When a toner having too small a particle diameter is used for a transfer material having a significant irregular surface, the fixability tends to be insufficient. In contrast, when a toner having too large a particle diameter is used, dot representation is not sufficient and granularity in half-tone portions also deteriorate, resulting in failure to obtain high definition images. In addition, when such a toner is used for a transfer material having a significant irregular surface, the fixability tends to be insufficient.

In addition, it is also found that, when the nip time, meaning a time needed for the toner image on a transfer material to pass through the nip portion in the fixing device of the present invention formed between an endless belt and a pressing rotation body while the pressing rotation body sandwiches the endless belt with an opposing rotation body located opposing to the pressing rotation body, is from 35 to 70 ms, sufficient fixability and anti-offset property are obtained even when a toner having a small particle diameter is fixed on a transfer material having a significant irregular surface. When the nip time is too short, the fixability possibly deteriorates. When the nip time is too long, offset tends to occur. When the nip time is from 40 to 60 ms, the fixability and anti-offset property are further improved.

The nip time is calculated based on the rotation speed of a belt and a nip breadth. It is preferred that the nip breadth is from 5 to 15 mm in the direction of transferring a transfer material.

Further, it is preferred that at least one of the pressing rotation body and the opposing rotation body has an elastic layer having a rubber hardness of from 20 to 40 Hs. When at least one of the rotation bodies has too small a rubber hardness, the pressure between the rotation bodies is not sufficiently applied to the toner image on a transfer material. Therefore, the toner tends not to be properly fixed on the transfer material. In addition, such a rotation body has a low elasticity, meaning that the mechanical strength thereof becomes weak, resulting in a tendency of shortening the life length of the rotation body. In contrast, when both rotation bodies have too large a rubber hardness, the surface of a belt tends to receive damage, which leads to a short life length of the belt.

The rubber hardness mentioned above was measured by a durometer type A, which is a hardness tester using a spring, complying with JIS K-6253 (test method of stiffness of vulcanization rubber).

The rotation body other than the rotation body having an elastic layer must maintain a suitable pressured state against the rotation body having an elastic layer to obtain a sufficient fixability. Therefore the other rotation body preferably is a hard type or has an elastic body having a relatively high rubber hardness. For example, the rubber hardness of such a rotation body is preferably not less than 40 Hs and more preferably not less than 50 Hs.

Furthermore, it is preferred that the surface of the pressing rotation body is coated with a material containing fluorine and/or silicon. Thereby, when an extremely small amount of toner is offset to a belt, the offset toner is prevented from attaching to the pressing rotation body. When a toner is attached to a pressing rotation body, a problem occurs such that the toner fouls the side of a transfer material opposite to the side on which a copy image is fixed.

Further, the opposing rotation body preferably has an elastic layer, the rubber hardness of which is relatively small in comparison with that of the elastic layer of the pressing rotation body. Thereby, a sufficient fixability is obtained even when a transfer material having an irregular surface is used. Further, the nip portion is indented to the side of the opposing rotation body and thus the recording medium receives a force from the nip portion, the direction of the force being away from the endless belt (i.e., to the pressing rotation body), thereby preventing the recording medium from winding around the endless belt.

In addition, since the form factor SF-1 of the toner used is from 110 to 150, meaning that the toner is significantly close to a sphere, the toner has a good fixability. This is because when a toner has a form close to a sphere, the toner is thought to uniformly receive heat during fixing.

The form factor SF-1 represents the degree of roundness of a toner particle and is defined by the following relationship (1):
SF-1={(MXLNG)²(AREA)}×(100π/4) (1),
wherein, MXLNG represents a diameter of the circle circumscribing the image of a toner particle obtained, for example, by observing the toner particle with a microscope, and AREA represents the area of the image.

When a toner has a value of the form factor SF-1 of 100, the toner has a true sphere form. As the form factor SF-1 increases, the form of the toner particle becomes more irregular.

The form factor SF-1 is determined by the following method:
(1) photographs of 100 toner particles having a particle diameter not less than 2 μm randomly sampled are taken with a magnifying power of ×1,000 using a scanning electron microscope (S-800, manufactured by Hitachi Ltd.)
(2) image data are made through scanning the photographs with a scanner; and
(3) the image data are binarized and analyzed using an image analyzer (LUSEX 3 manufactured by Nireco Corp.) to obtain the form factor.

In addition, in a preferred embodiment of the image forming apparatus of the present invention, since a heating roller contained therein is made of a magnetic metal and heated by electromagnetic induction, it is possible to quickly heat the belt during electromagnetic induction, resulting in advantages such as high thermal efficiency.

The electromagnetic generation device and the heating roller are provided outside the pressing rotation body and the opposing rotation body with the endless belt therebetween. Therefore, the thermal efficiency for the belt is relatively high in comparison with the case in which a heat source is provided inside the pressing rotation body or the opposing rotation body, resulting in uniform fixing.

That is, when a heat source is provided inside the rotation bodies, an elastic layer such as a rubber layer having a certain thickness needs to be provided around the heat source because the rotation bodies mentioned above are pressed against each other. As a result, this is a disadvantage because such an elastic layer consumes a significant amount of heat. In contrast, different from the pressing rotation body and the opposing rotation body, the heating roller does not require a strong anti-pressure property, thereby eliminating the necessity of a thick layer around the heat source which reduces the thermal efficiency.

Further, the electromagnetic induction generation device is preferably provided externally because of the following reasons. When an electromagnetic induction generation device is provided inside the heating roller, the diameter thereof extremely increases. In addition, to protect the inside of the heating roller from the pressure from outside, the surrounding layer is thickened, resulting in deterioration of the thermal efficiency. Further, an external electromagnetic induction generation device has advantages in terms of temperature controllability and wide variety of placement thereof.

Furthermore, when the pressing rotation body contains a heat source therein, the pressing rotation body can uniformly apply a sufficient amount of heat to a transfer material from the backside thereof, resulting in good fixability. This is effective even when a transfer material having a rough surface is used.

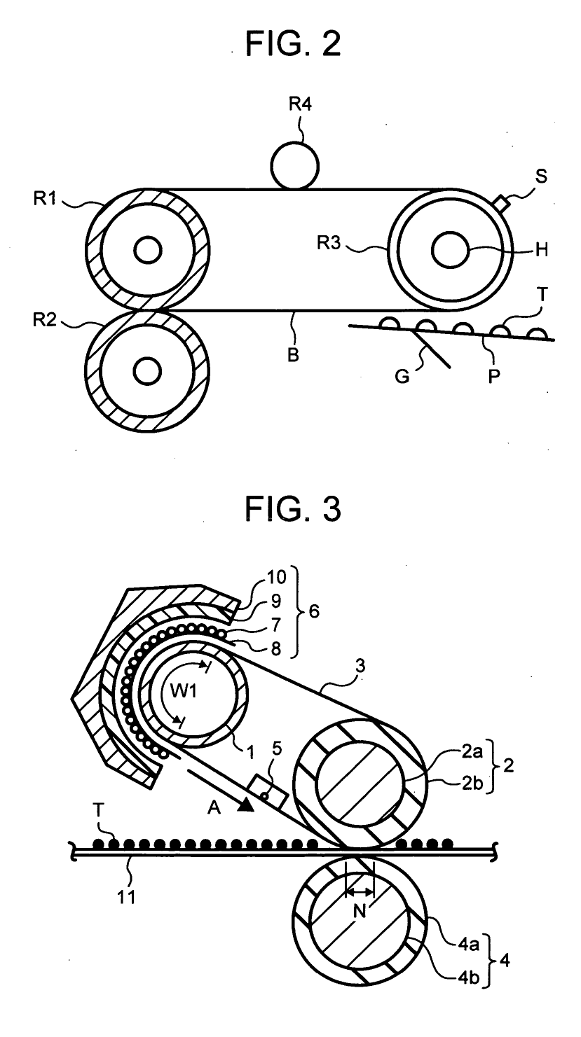

FIG. 2 is a diagram illustrating an example of the fixing device for use in the fixing system of the present invention. In FIG. 2, R1 represents a fixing roller having a core made of a metal such as aluminum and iron which is covered by an elastic body such as silicone rubber. Character R3 represents a heating roller made of a core having a pipe form made of a metal such as aluminum, iron, copper and stainless metal and a heat source H inside. Character S represents a temperature detector to measure the surface temperature of a portion of a fixing belt B which is in contact with the heating roller R3. The fixing belt B is suspended over the fixing roller R1 and the heating roller R3. The fixing belt B has a structure having a small thermal capacity and includes a substrate and a release layer provided thereon. The substrate is made of, for example, nickel and polyimide having a thickness of from about 30 to about 150 μm. The release layer is made of, for example, a silicone rubber having a thickness of from about 50 to about 300 μm or fluorine containing resin having a thickness of from about 10 to about 50 μm. When an electromagnetic induction system is adopted, a unit including a metal core is provided inside the heating roller R3 and a layer of, for example, silver foil is provided inside the belt B to heat the surface of the belt B.

A pressing roller R2 includes a metal core covered with an elastic body, and forms a nip portion with the fixing belt B by pressing the fixing roller R1 from below with the fixing belt B between the pressing roller R2 and the fixing roller R1. An oil application roller R4 impregnating oil is optionally provided to apply oil such as silicone containing oil to the fixing belt B. A guide G is a guide supporting a print sheet P such as paper which bears an unfixed toner image T. In addition, the dimensions of these members are set depending on each requisition. This is just an example and it is possible, for example, to provide a heat source inside the fixing roller R1 and/or the pressing roller R2. In the present invention, a fixing device having a fixing belt having a different structure from the structure of the example can also be applicable to the present invention.

It is preferred that such a fixing device, especially an oilless type fixing device or a fixing device applying only a little amount of oil, fixes a toner containing a release agent which is fine-dispersed in the toner. A toner in which a release agent is finely-dispersed is easy to exude during fixing. Therefore, in the case of an oilless fixing device or a fixing device which applies only a little amount of oil even when the oil application effect decreases, it is possible to restrain transition of the toner to the belt. To disperse a release agent in a toner, it is preferred that the release agent and a binding resin are not compatible with each other. Also, to finely disperse a release agent in a toner, for example, the shearing force applied during a melting and kneading process when manufacturing a toner can be used to obtain such a toner. The dispersion state of a release agent in a toner can be determined by observing a thin section of a toner particle with a transmittance electron microscope (TEM). It is preferred that the dispersion particle diameter of such a release agent is small. However, when the dispersion particle diameter is too small, exudation of the release agent during fixing may not be sufficient. When a release agent is observed with a magnifying power of 10,000, it is determined that the release agent is present in a dispersion state. When a release agent is not observed with a magnifying power of 10,000, exudation of the release agent during fixing may not be sufficient even if the release agent is finely dispersed.

With regard to materials for use in the toner of the present invention, any known material can be used. Specific examples of the binder resins include styrene polymers and their substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylatecopolymers, styrene-ethylacrylatecopolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; polymethyl methacrylate, polybutyl methacrylate, polyvinyl chloride, polyvinyl acetate, polyethylene, polypropylene, polyesters, epoxy resins, epoxypolyol resins, polyurethane, polyamide, polyvinyl butyral, polyacrylate resins, rosins, modified rosins and terpene resins. These resins can be used alone or in combination.

Suitable colorants for use in the toner of the present invention include any known dyes and pigments.

Specific examples of the colorants include carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmiummercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

The content of the colorant in a toner is from 0.1 to 50 parts by weight based on 100 parts by weight of a binder resin.

Specific examples of release agents contained in the toner in the present invention include natural waxes such as candelilla waxes, carnauba waxes and rice waxes, montan waxes, paraffin waxes, sasol waxes, polyethylene having a low molecular weight, polypropylene having a low molecular weight and alkyl phosphate esters. These can be used alone or in combination.

The toner can optionally contain a controlling agent in the present invention. Specific examples of such controlling agents include metal complex salts of monoazo dyes, nitrohumic acid and its salts, quaternary ammonium salts, imidazole metal complexes and salts, metal complexes and metal salts of Co, Cr, Fe, Zn, Zr, and Al of salicylic acid, naphthoic salts, dicarboxylic acid, amino compounds, organic boron salts, calyxarene containing compounds and organic dyes. A transparent or white material is selected among these and added to a color toner to avoid impairing the tone of the color. Also such a charge controlling agent is preferred to impart negative or positive stability to a toner.

The content of the charge controlling agent is determined depending on the species of the binder resin used, whether or not an additive is added and the toner manufacturing method including a dispersion method, and is not particularly limited. The content of the charge controlling agent is preferably from 0.1 to 10 parts by weight, and preferably from 2 to 5 parts by weight, per 100 parts by weight of the binder resin included in a toner. When the content thereof is too small, such a toner is not practically usable because the toner is not sufficiently charged. When the content is too large, the toner is excessively charged. Thereby the electrostatic force between the toner and a carrier increases, resulting in deterioration of the fluidity of the developer and decrease in the image density of toner images.

Further, when a magnetic material is contained in a toner particle, metal oxides such as ferrite, magnetite and, maghematite, metals such as Fe, Co and, Ni and alloys of these with other metals can be used alone or in combination. Also in this case, when such a magnetic material is used for a color toner, it is preferred to select a transparent or white material to avoid impairing the tone of the color.

The toner of the present invention can also contain known additives to improve toner fluidity and environment dependency. Specific examples of such additives include inorganic powders of zinc oxide, tin oxide, aluminum oxide, titanium oxide, silicon oxide, strontium titanate, barium titanate, calcium titanate, strontium zirconate, calcium zirconate, lanthanum titanate, calcium carbonate, magnesium carbonate, mica, dolomite and their hydrophobic compounds. These can be used alone or in combination.

Other additives such as fluorine resin particulates of polytetrafluorene, tetrafluoroethylene hexafluoropropylene coplymers and polyvinylidene fluoride can be used as a toner surface improver. Approximately 0.1 to 10 parts by weight based on 100 parts by weight of a mother toner particle is externally added depending on the kind of materials added. If necessary, these additives are mixed by a mixer to control the state thereof in a toner, i.e., whether the additives are in the state in which the additive is attached or adhered to the surface of a toner particle or isolated in the space formed between toner particles.

The toner particles can be manufactured by mixing and kneading the materials mentioned above in a known kneading process using kneaders and extruders such as a two-roll kneader, a two-axis kneader and a one-roll extruder followed by pulverizing and classifying the mixture in known pulverizing and classifying processes such as mechanical pulverization and air-classification. Further, the toner particles can be manufactured by a polymerization method. How to granulate toner particles are not limited to these known methods.

Next, the method of measuring the weight average particle diameter of a toner particle is described.

Specific examples of devices for measuring the size distribution of toner particles using the Coulter method include Coulter Counter TA-II and Coulter Multisizer II (both are manufactured by Beckman Coulter Inc.). The measuring method is described below.

(1) Add 0.1 to 5 ml of a surface active agent (preferably a salt of an alkyl benzene sulfonate) as a dispersant to 100 to 150 ml of an electrolytic aqueous solution. The electrolytic aqueous solution is an about 1% NaCl aqueous solution prepared by using primary NaCl, e.g., ISOTON-II®, manufactured by Beckman Coulter Inc.

(2) Add 2 to 20 mg of a measuring sample to the electrolytic aqueous solution.

(3) The electrolytic aqueous solution in which the measuring sample is suspended is subject to a dispersion treatment with a supersonic disperser for about 1 to 3 minutes.

(4) Measure the volume and the number of the toner particles or the toner by the measuring device mentioned above with the aperture set to 100 μm.

(5) Calculate the volume distribution and the number of toner particle distribution.

The weight average particle diameter (D4) of the toner can be obtained from the obtained distributions.

The particles measured have a particle diameter of from 2.00 to less than 40.30 μm and the number of the channels is 13. The channels used are: from 2.00 to less than 2.52 μm; from 2.52 to less than 3.17 μm; from 3.17 to less than 4.00 μm; from 4.00 to less than 5.04 μm; from 5.04 to less than 6.35 μm; from 6.35 to less than 8.00 μm; from 8.00 to less than 10.08 μm; from 10.08 to less than 12.70 μm; from 12.70 to less than 16.00 μm, from 16.00 to less than 20.20 μm; from 20.20 to less than 25.40 μm; from 25.40 to less than 32.00 μm; and from 32.00 to less than 40.30 μm.

In the present invention, singly toner can be used as a single component developer for image development and a developer containing a toner and a carrier can be used as a double component developer for image development. Known carriers such as iron powder, ferrite and glass beads can be used in a double component developer. These carriers can be covered with a resin. The resins used in this case are, for example, carbon-fluorine polymers, polyvinyl chloride, polyvinlydene chloride, phenol resins, polyvinyl acetal and silicone resins. The suitable mixture ratio of the toner to the carrier is typically from about 0.5 to about 6.0 parts by weight based on 100 parts by weight of the carrier.

Next, the embodiment in the second case of the present invention related to the full-color image forming apparatus and method using an intermediate transfer device will be described.

The present inventor found that, in the process in which images are developed with a color toner using an intermediate transfer device, sufficient fixability is obtained under the following condition (A) even when the image development is performed using a toner having a small particle diameter of from 2 to 5 μm and a transfer paper having a surface smoothness not greater than 40 sec. The condition (A) is: a combination of the nip pressure of from 2 to 10 N/cm² during the secondary transferring from the intermediate transfer device and the nip pressure of a fixing member of from 10 to 50 N/cm². The present inventor also found that, when the fixing process is performed by a fixing device including an endless belt having an elastic layer on its surface, a plurality of rotation bodies located inside the endless belt, at least one of which is a heating roller, and a pressing rotation body located outside the endless belt and configured to form a nip portion with the endless belt while sandwiching the endless belt with one of the rotation bodies placed opposite to the pressing rotation body, the fixability can be further improved by combining the condition (A) mentioned above and the following condition (B) even for a transfer paper having a surface smoothness not greater than 40 sec. The condition (B) is: at least one of the pressing rotation body and the rotation body located opposite thereto included in a fixing device has an elastic layer having a rubber hardness of from 20 to 40 Hs and the nipping time is from 35 to 70 ms.

The embodiment in the second case of the present invention, i.e., the full color image forming apparatus, is now described.

Although it is not clear how sufficient fixability is obtained for a paper having a rough surface by the present invention, it is thought that, even the thermal efficiency and the transfer state from a macro point of view are the same, the uniformity of the layers of toner are improved at a micro level so that the toner layers are not disturbed by fixing members during fixing and further the toner is sufficiently fixed under a constant fixing condition.

Since the nip pressure during the secondary pressure is from 2 to 10 N/cm², the uniformity of the layer of the toner on a transfer material is improved so that good fixability is obtained even when the transfer material has an irregular surface.

When the nip pressure during the secondary transfer is too small, sufficient fixability may not be obtained. In contrast, when the nip pressure during the secondary transfer is too large, offset may occur and passability of a transfer material may deteriorate.

In addition, since the nip pressure during fixing is from 10 to 50 N/cm², good fixability is obtained under the conditions for the transfer material mentioned above to which the toner is uniformly transferred. When the nip pressure during fixing is too small, sufficient fixability may not be obtained. In contrast, when the nip pressure during fixing is too large, offset may occur and passability of a transfer material may deteriorate.

In addition, when the full color image forming apparatus mentioned above is used, since the form factor SF-1 of the toner is from 110 to 150, meaning that the toner particle form is significantly close to a sphere, the fixability can be improved. This is because when a toner has a form close to a sphere, the toner is thought to uniformly receive heat during fixing and resultantly an image is uniformly transferred to a transfer material. When SF-1 of a toner is too small, the toner may scatter during development and transfer, resulting in deterioration of the image quality, and may remain on an image bearing member without being transferred, resulting in deterioration of cleanability. Further, the toner may scatter during fixing. To the contrary, when SF-1 of a toner is too large, the image uniformity during development may deteriorate, and the transfer efficiency from an image bearing member to an intermediate transfer device or a transfer material, or from an intermediate transfer device to a transfer material, may deteriorate, resulting in insufficient fixability.

Further, the problems such that the amount of charge and developability of a color toner vary because external additives are embedded in the surface of the color toner by stirring in the developing device to obtain good property for the secondary transfer, can be solved by attaching fine particles having a number average particle diameter of from 0.04 to 0.30 μm to the surface of the color toner.

When the average particle diameter of the fine particles is too small, such fine particles tend to sink in the surface of the toner particles by stirring, etc., in a developing device over a long period of time, resulting in deterioration of the transferability and fixability. When the average particle diameter of the fine particle is too large, the fixability of a toner may be impaired.

The color toner for use in the present invention preferably contains a release agent and the ratio of the release agent is from 3 to 10 weight % based on the weight of the color toner. When the ratio of a release agent is within this range, it is possible to impart a sufficient oilless fixability to a toner. When the ratio of a release agent is too small, the oilless fixability may not be sufficiently obtained. In contrast, when the ratio of a release agent is too large, the toner may not be sufficiently transferred, resulting in deterioration of the fixability thereof.

In addition to the release agents mentioned above, other release agents such as carbonyl group containing waxes can be used in the present invention. Specific examples of the waxes having a carbonyl group include polyalkanoic acid esters such as carnauba waxes, montan waxes, trimethylolpropane tribehenate, pentaerythritol tetrabehenate, pentaerythritol diacetate dibehenate, glycerin tribehenate, and 1,18-octadecanediol distearate; polyalkanol esters such as tristearyl trimellitate, and distearyl maleate; polyalkanoic acid amides such as ethylenediamine dibehenylamide; polyalkylamide such as trimellitic acid tristearylamide; dialkyl ketone such as distearyl ketone; etc.

The melting point of the release agent for use in the present invention is preferably from 50 to 120° C. and more preferably from 60 to 90° C. When the melting point of a release agent is too low, such a release agent adversely affects the high temperature preservability of the toner. When the melting point of a release agent is too high, such a release agent causes cold offset at low temperature fixing. Further, the fusion viscosity of a release agent is preferably 5 to 1,000 cps and more preferably 10 to 100 cps when measured at a temperature 20° C. higher than its melting point. When the fusion viscosity is too high, such a release agent has a poor improvement effect on hot offset resistance and low temperature fixability. When the fusion viscosity is too low, high temperature preservability tends to deteriorate.

Colorants for use in the toner for use in the full color image forming apparatus of the present invention can be used in a master batch in which the colorants mentioned above are mixed with a resin. The binder resins mentioned above can be used when manufacturing a master batch or can be kneaded with a master batch.

The master batch is typically prepared by mixing and kneading a resin and a colorant upon application of high shear stress thereto. In this case, an organic solvent can be used to boost the interaction of the colorant with the resin. In addition, flushing methods in which an aqueous paste including a colorant is mixed with a resin solution of an organic solvent to transfer the colorant to the resin solution and then the aqueous liquid and organic solvent are separated to be removed is preferably used because the resultant wet cake of the colorant can be used as it is, i.e., there is no need for the wet cake to be dried. In this case, a high shear stress dispersion device such as a three-roll mill is preferably used for mixing and kneading.

In addition, the color toners for use in the present invention are preferably prepared in an aqueous medium. The color toners prepared in an aqueous medium are effective to obtain the small particle diameter and the form in the present invention.

Specific examples of methods of manufacturing toners include suspension polymerization methods, emulsification association methods and melting suspension methods but are not limited thereto In addition, the full color image forming apparatus preferably adopts a tandem system for an electrophotographic image forming process.

In the tandem system, as one of the full color recording system in an electrophotographic system, in which a plurality of image bearing members develop images color by color when each bearing member rotates, the latent electrostatic image forming process and the development/transfer process are performed for each color to form each color toner image. Therefore, the difference in the image formation speed between the tandem system and a system for single color images is small and thereby the tandem system has an advantage in that the tandem system is capable of dealing with a high speed printing. However, since each toner image is formed on separate latent image bearing members and overlapped to form a full color image, variance among the color tones obtained for a full color image may become large due to the variance in the amount of the development toner particles for each color caused by a difference in characteristics thereof such as charge ability. That is, color reproduction property deteriorates.

In addition, a color image is formed by transferring each toner image formed on each image bearing member to an image forming supporting member and fixing the overlapped image. Therefore, when there is a difference among the attachment property of toner particles of each color to the image forming supporting member, stabilizing the image during fixing is difficult, resulting in deterioration of a color reproduction property. When a typical toner prepared by a pulverization method is used, the surface property thereof tends to vary among the toner particles because materials dispersed in the pulverized toner particle are not uniformly present in its fractured cross section. Meaning, it is difficult to stabilize the amount of development toner among each color toner particle and have a uniform attachment property to the image forming supporting member. As a result, developability and transferability of an image possibly vary, which leads to deterioration of the color image quality. Especially when transferability is different for each color, color reproducibility tends to deteriorate and partial transfer omission easily occurs.

When a toner for use in the image forming method adopting the tandem system is used, it is necessary to stabilize the amount of the development toner to control the balance among each color (i.e., there is no variance among toner particles of each color), and it is also necessary to have a uniform attachment property among toner particles of each color to a latent image bearing member and an image forming supporting member.

For such issues related to the tandem system, the process of the present invention efficiently exerts the effects mentioned above, thereby obtaining a uniform transferability and fixability even when a transfer material having a rough surface is used.

In addition, since the intermediate transfer device is made of a single resin layer, the transfer electric field generated during transfer uniformly acts on the intermediate transfer device. Therefore, images are sufficiently and uniformly transferred even when a transfer paper has a rough surface.

The latent electrostatic image bearing member for use in the present invention is preferably an amorphous silicon photoreceptor. This amorphous silicon photoreceptor is now described below.

(Amorphous Silicon Photoreceptor)

Amorphous silicone photoreceptors (hereinafter referred to as a-Si photoreceptor) for use in the electrophotofraphic photoreceptor of the present invention include an electroconductive substrate and photoconductive layer containing a-Si. The photoconductive layer is formed on the electroconductive substrate heated to from 50 to 400° C. by a film forming method such as vacuum deposition methods, sputtering methods, ion plating methods, thermal chemical vapor deposition (CVD) methods, optical chemical vapor deposition (CVD) methods and plasma chemical vapor deposition (CVD) methods. Among them, plasma chemical vapor deposition (CVD) methods are preferred, in which a material gas is decomposed by direct current or high frequency or microwave glow discharge to form an a-Si accumulation layer on a substrate.

(Layer Structure)

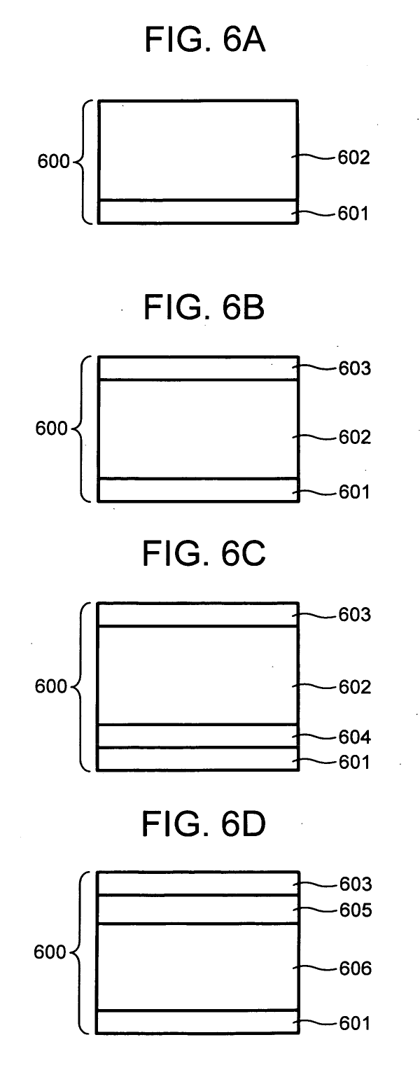

The layer structure of the amorphous silicon photoreceptor is, for example, as follows. FIGS. 6A to 6D are diagrams illustrating examples of the schematic layer structure. A photoreceptor 600 for electrophotography illustrated in FIG. 6A includes a substrate 601 on which a photoconductive layer 602 made of a-Si:H, X and having photoconductivity is provided.

The photoreceptor 600 for electrophotography illustrated in FIG. 6B includes the substrate 601 on which the photoconductive layer 602 made of a-Si:H, X and having photoconductivity, and an amorphous silicone containing surface layer 603 is provided.

The photoreceptor 600 for electrophotography illustrated in FIG. 6C includes the substrate 601 on which the photoconductive layer 602 made of a-Si: H, X and having photoconductivity, the amorphous silicone containing surface layer 603 and an amorphous silicon containing charge injection protection layer 604 are provided. The photoreceptor 600 for electrophotography illustrated in FIG. 6D includes the substrate 601 on which the photoconductive layer 602 is provided. The photoconductive layer 602 includes a charge generation layer 605 made of a-Si:H, X and a charge transport layer 606 on which the amorphous silicone containing surface layer 603 is provided.

(Substrate)

The substrate 601 for the photoreceptor can be of electroconductivity or electrical insulation. The electroconductive substrate 601 is made of metals such as Al, Cr, Mo, Au, In, Nb, Te, V, Ti, Pt, Pdand Fe, and their alloys such as stainless alloys. Also, an electrically insulative substrate 601 can be used as long as at least the surface on which the photoconductive layer 602 is formed is electroconductively treated. The insulative substrate 601 is formed of a film or a sheet of a synthetic resin such as polyester, polyethylene, polycarbonate, cellulose acetate, polypropylene, polyvinyl chloride, polystyrene and polyamide, glass or ceramics.

The substrate 601 can have a cylindrical form, a plate form or an endless belt form and its surface can be smooth or rough. The thickness of the substrate 601 can be suitably determined to form a desired photoreceptor for an image forming apparatus. When flexibility is required for such a photoreceptor for use in an image forming apparatus, its substrate can be made as thin as possible unless the functionality thereof is impaired. However, the substrate 601 typically has a thickness not less than 10 μm to secure a mechanical strength in terms of its manufacturing and handling.

(Injection Protection Layer)

With regard to the amorphous silicon photoreceptor for use in the present invention, it is further effective to provide the charge injection protection layer 604 having a function of preventing charge injection from the electroconductive substrate 601 between the electroconductive substrate 601 and the photoconductive layer 602 if necessary (refer to FIG. 6C). The charge injection prevention layer 604 has a function of preventing charge injection from the substrate 601 to the photoconductive layer when the photoconductive layer is negatively or positive charged on its free surface but does not have such a function when the photoconductive layer 602 is reversely charged. Meaning that the function of the charge injection prevention layer 604 is polarity-dependent. To impart such a function, the charge injection prevention layer 604 contains more atoms controlling electroconductivity than the photoconductive layer does.

The charge injection prevention layer 604 preferably has a thickness of from 0.1 to 5 μm, more preferably from 0.3 to 4 μm and optimally from 0.5 to 3 μm in terms of desired electrophotographic properties and cost.

(Photoconductive Layer)

The photoconductive layer 602 can be formed on an undercoat layer on a necessity basis. The thickness of the photoconductive layer 602 is suitably determined in light of desired electrophotographic properties and cost and is preferably from 1 to 100 μm, more preferably from 20 to 50 μm and optimally from 23 to 45 μm.

(Charge Transport Layer)

The charge transport layer 606 is a layer having a function of transporting charge when the photoconductive layer 602 is functionally separated. The charge transport layer 606 at least contains silicon atoms, carbon atoms and fluorine atoms and can be made of a-SiC (H, F, O), which further contains hydrogen atoms and oxygen atoms if necessary, to have desired photoconductive characteristics, especially charge preservation characteristics, charge generation characteristics and charge transport characteristics. In the present invention, it is particularly preferred to have oxygen atoms in the charge transport layer 606.

The thickness of the charge transport layer 606 is determined in light of desired electrophotographic properties and cost and is preferably from 5 to 50 μm, more preferably from 10 to 40 μm and optimally from 20 to 30 μm.

(Charge Generation Layer)

The charge transport layer 605 is a layer having a function of generating charges when the photoconductive layer 602 is functionally separated. The charge generation layer 605 at least contains silicon atoms but does not actually contain carbon atoms and is made of a-Si:H, which further contains hydrogen atoms if necessary to have a desired photoconductive characteristics, especially charge generation characteristics and charge transport characteristics. The thickness of the charge generation layer 605 is determined in light of desired electrophotographic properties and cost and is preferably from 0.5 to 15 μm, more preferably from 1 to 10 μm and optimally from 1 to 5 μm.

(Surface Layer)

It is preferred that the amorphous silicon photoreceptor can further have the surface layer 603 on the photoconductive layer 602 formed on the substrate 601 as mentioned above if necessary to form the surface layer 603 containing amorphous silicon. The thickness of the charge surface layer 603 is typically from 0.01 to 3 μm, preferably from 0.05 to 2 μm and optimally from 0.1 to 1 μm. When the thickness of the surface layer 603 is too thin, the surface layer 603 is lost due to abrasion while the photoreceptor is used. When the thickness of the surface layer 603 is too thick, deterioration of electrophotographic characteristics such as residual potential increase is observed.

(Development of Latent Images on Latent Electrostatic Image Bearing Member)

In the present invention, when developing a latent image on the latent electrostatic image bearing member, it is preferred to apply an alternative electric field.

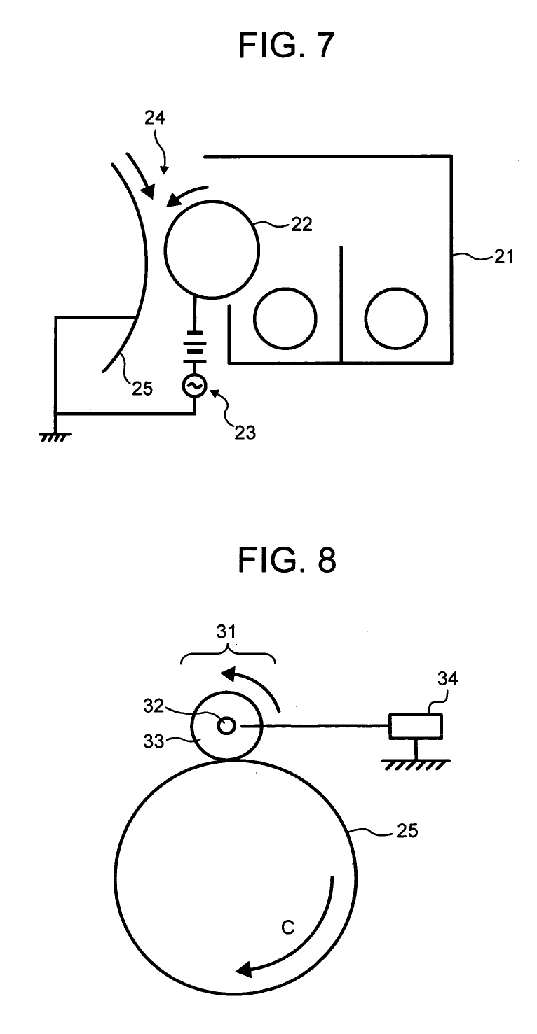

In FIG. 7, a power supply 23 applies a developing bias, which is a vibration bias potential in which an alternative current potential is overlapped on a direct current potential, to a developing sleeve 22 in a developing device 21 while in development. The background portion potential and the image portion potential are between the maximum potential and the minimum potential of the vibration bias potential mentioned above. Thereby, an alternative electric field in which the direction is alternatively changed is formed in a developing portion 24. In this alternative electric field, toner particles and carrier particles in a developer violently vibrate and then the toner particles overcome the electrostatic force received from the development sleeve 22 and the carrier particles and fly and attach to a photoreceptor drum 25 according to a latent image formed on the photoreceptor drum 25.

The difference between the maximum value and the minimum value of the vibration bias potential (potential between the peaks) is preferably from 0.5 to 5 kV and the frequency is preferably from 1 to 10 kHz. The vibration bias potential can have a waveform such as square form, sinusoidal waveform and triangular waveform. The component of the direct current in the vibration bias potential is between the background portion potential and the image portion potential as mentioned above and is preferably closer to the background portion potential. This is preferred in that fogging of the toner to the area of the background portion potential can be prevented.

When the vibration bias potential has a square waveform, its duty ratio is preferably not greater than 50%. The duty ratio means the ratio of the period of time in one cycle of the vibration bias potential in which the toner particles fly toward the photoreceptor

(Charging System)

The charging devices illustrated in FIGS. 7 and 8 can be used as the charging device for use in the image forming method of the present invention.

(Roller System Charging)

FIG. 8 is a diagram illustrating an example of the schematic structure of an image forming apparatus using a contact type charging device. The photoreceptor drum 25, which is a charged body and an image bearing member, is rotationally driven along the direction of an arrow C at a predetermined speed (i.e., processing speed). A charging roller 31 functioning as a charging member, which is in contact with the photoreceptor drum 25, basically contains a core metal 32 and an electrocondcutive rubber layer 33 which is coaxially formed around the core metal. Both ends of the core metal 32 are supported by, for example, an axis bearing member (not shown), in such a manner that the core metal 32 can freely rotate. In addition, the charging roller 31 is pressed against the photoreceptor drum 25 with a predetermined pressure by a pressing device (not shown). Further, in this figure, the charging roller 31 is rotated by the rotation of the photoreceptor drum 25. The charging roller 31 has a diameter of 16 mm and contains the core metal 32 having a diameter of 9 mm which is covered with a rubber electrically-resistive layer having a resistance in the intermediate range, i.e., about 100,000 Ωcm.

The core metal 32 of the charging roller 31 and a power supply 34 are electrically connected and the power supply 34 applies a predetermined bias to the charging roller 31. Thereby, the surface of the photoreceptor 25 is uniformly charged to a predetermined potential with a predetermined polarity.

The charging member for use in the present invention can have any form such as a magnetic brush form and a fur brush form other than the roller form mentioned above and any form can be selected according to the requisitions and configuration of the elecrophotographic apparatus. When a magnetic brush is used, the magnetic brush uses a charging member made of various kinds of ferreite particles such as Zn—Cu ferrite, a non-magnetic electroconductive sleeve supporting the charging member, and a magnetic roll contained in the non-magnetic electroconductive sleeve. In addition, a fur which has been electroconductively treated by carbon, copper sulfide, metals, and metal oxides can be used. Such a fur is wound around or attached to a metal or a core metal which has been finished with electroconductive treatment to form a charging device.

(Fur Brush System Charging)

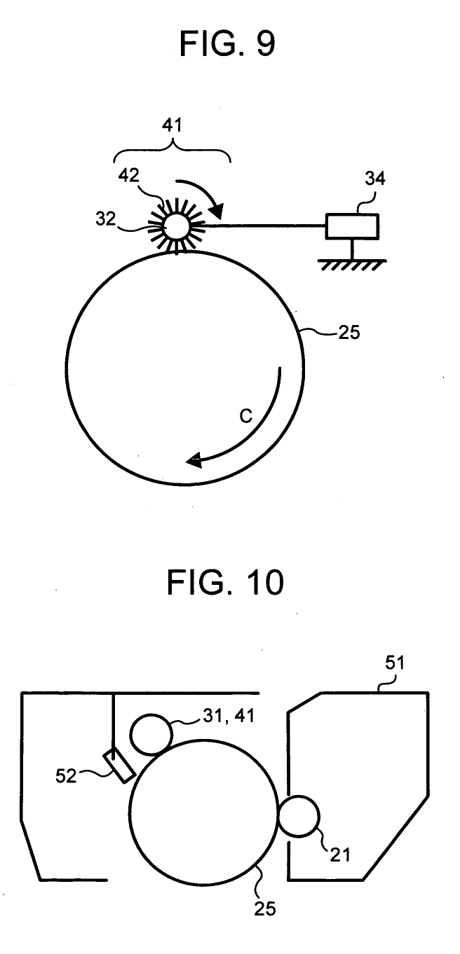

FIG. 9 is a diagram illustrating an example of the schematic structure of an image forming apparatus using a contact type charging device. The photoreceptor drum 25, which is a charged body and an image bearing member, is rotationally driven along the direction indicated by an arrow C at a predetermined speed (i.e., processing speed). A brush roller 41 including a fur brush is brought into contact with the photoreceptor drum 25 under a predetermined pressure against the elasticity of a brush portion 42 with a predetermined nip width.

The fur brush roller 41 functioning as the contacting charging member in this example is a roll brush having, e.g., an outer diameter of 14 mm and a longitudinal extent of 250 mm which includes a metal core having a diameter of 6 mm, which also functions as an electrode, and a pile fabric tape (electroconductive rayon REC-B manufactured by Unitika Ltd.) forming a brush portion which is spirally wound around the core metal 32. The brush in the brush portion 42 has a 300 denier/50 filament and a density of 155/mm². This roll brush is inserted into a pipe having an inner diameter of 12 mm while rotating the roll brush in one direction in a manner that the brush and the pipe are coaxial. Thereafter, the pipe and the brush are left in a high temperature and high humidity environment to set the brush to be slanted.

The fur brush roller 41 has a resistance of 1×10⁵ Ω upon application of 100 volt. This resistance is calculated by the current obtained when 100 volt is applied to a metal drum having a diameter of 30 mm with which the fur brush roller is in contact with a nip width of 3 mm.

The resistance of the fur brush charging device is at least 1×10⁴ Ω to prevent a poor image caused by a poor charging at the nip portion when an excessive leak current flows into a low resistance deficient portion caused by a pin hole, etc., on the photoreceptor functioning as a charged body. Further, to sufficiently charge the surface of the photoreceptor, the resistance is not greater than 1×10⁷ Ω.

In addition, as the materials for the brush, other than REC-B manufactured by Unitika Ltd., REC-C, REC-ML, REC-M10, SA-7 manufactured by Toray Industries, Inc., THUNDERON® manufactured by Nihon Sanmo Dyeing Co., Ltd., BELLTRON® manufactured by Kanebo Ltd., KURACARBO® manufactured by Kuraray Co., Ltd., and a rayon in which carbon is dispersed, can be used. A piece of the brush preferably has from 3 to 10 denier, 10 to 100 filament/bundle, a density of from 80 to 600 pieces/mm. The length of the piece of the brush is preferably from 1 to 10 mm.

This fur brush roller 41 is rotationally driven at a predetermined linear velocity (i.e., the surface speed) in the counter direction of the rotation direction of the photoreceptor drum 25. Therefore, the fur brush roller 41 is in contact with the surface of the photoreceptor drum 25 with a speed difference therebetween. A predetermined bias is applied to this fur brush roller 45 by the power supply 34. The surface of the rotating photoreceptor drum 25 is uniformly charged to a predetermined potential with a predetermined polarity while in contact with the fur brush 41. In this example, the contact charging of the photoreceptor drum 25 by the fur brush roller 41 is dominantly a direct pouring charging. Therefore, the surface of the rotating photoreceptor drum 25 has almost the same potential as the potential applied to the fur brush roller 41.

(Magnetic Brush Charging)

FIG. 9 is a diagram illustrating an example of the schematic structure of the image forming apparatus using a contact type charging device. The photoreceptor drum 25, which is a charged body and an image bearing member, is rotationally driven along the direction indicated by an arrow C at a predetermined speed (i.e., processing speed). A brush roller 41 containing a magnetic brush is brought into contact with the photoreceptor drum 25 under a predetermined pressure against the elasticity of a brush portion 42 with a predetermined nip width.

For the magnetic brush 41 functioning as the contacting charging member in this example, magnetic particles containing ferrite particles on which a resin layer having a resistance in the intermediate range are coated are used. The magnetic particles contain ferrite particles having an average particle diameter of 25 μm which are prepared by mixing Zn—Cu ferrite particles having an average particle diameter of 25 μm with Zn—C ferrite particles having a particle diameter of 10 μm with the ratio of 1 to 0.05 while both ferrite particles have their peaks at their average particle diameter. The contacting type charging member contains the coated magnetic particles mentioned above, an electroconductive sleeve supporting the particles and a magnet roll contained in the electroconductive sleeve. The coated magnetic particles are coated on the electroconductive sleeve with a thickness of 1 mm and form a charging nip portion having a width of about 5 mm with the photoreceptor drum 25. In addition, the gap between the magnetic particle supporting sleeve and the photoreceptor drum 25 is about 500 μm. Further, the magnet roll is rotated in such a manner that the surface of the sleeve is abraded in the counter direction of the linear velocity of the photoreceptor drum 25 at the double speed of that of the photoreceptor drum 25. Therefore, the photoreceptor drum 25 and the magnetic brush 41 are uniformly contacted.

(Process Cartridge)

The developer for use in the present invention can be used in an image forming apparatus having a process cartridge 51 as illustrated in FIG. 10.

In the present invention, at least two of the photoreceptor 25, the charging device 31,41, the developing device 21 mentioned above and a cleaning device 52 can be integrally combined as the process cartridge 51. The process cartridge 51 can be detachably attached to the body of an image forming apparatus such as a photocopier and a printer.

FIG. 10 is a diagram illustrating the process cartridge 51 containing the photoreceptor drum 25, the charging device 31,41, the developing device 21 and the cleaning device 52. The process cartridge 51 operates as follows:
(1) The photoreceptor drum 25 is rotationally driven at a predetermined circumference velocity;
(2) The circumference surface of the photoreceptor drum 25 is uniformly charged negatively or positively by the charging device 31 or 41 in its rotation cycle;
(3) The circumference surface of the photoreceptor drum 25 is irradiated by an image irradiation device such as a slit irradiation device and a laser beam scanning irradiation device;
(4) Consequently a latent electrostatic image is formed on the surface of the photoreceptor drum 25;
(5) The formed latent electrostatic image is developed with a toner by the developing device 21;
(6) The developed toner image is transferred by a transfer device to a transfer material fed from a paper feeder to a portion formed between the photoreceptor drum 25 and the transfer device synchronously with the rotation of the photoreceptor drum 25;
(7) The transfer material to which the toner image is transferred is detached from the surface of the photoreceptor drum 25 and guided to an image fixing device at which the transferred image is fixed; and
(8) The fixed image is discharged outside the apparatus as a copy.
(9) The surface of the photoreceptor drum 25 is then cleaned by the cleaning device 52 which removes the toner particles remaining on the photoreceptor drum 25 after transfer and is further discharged to be ready for the next image forming cycle.

### Embodiment 1

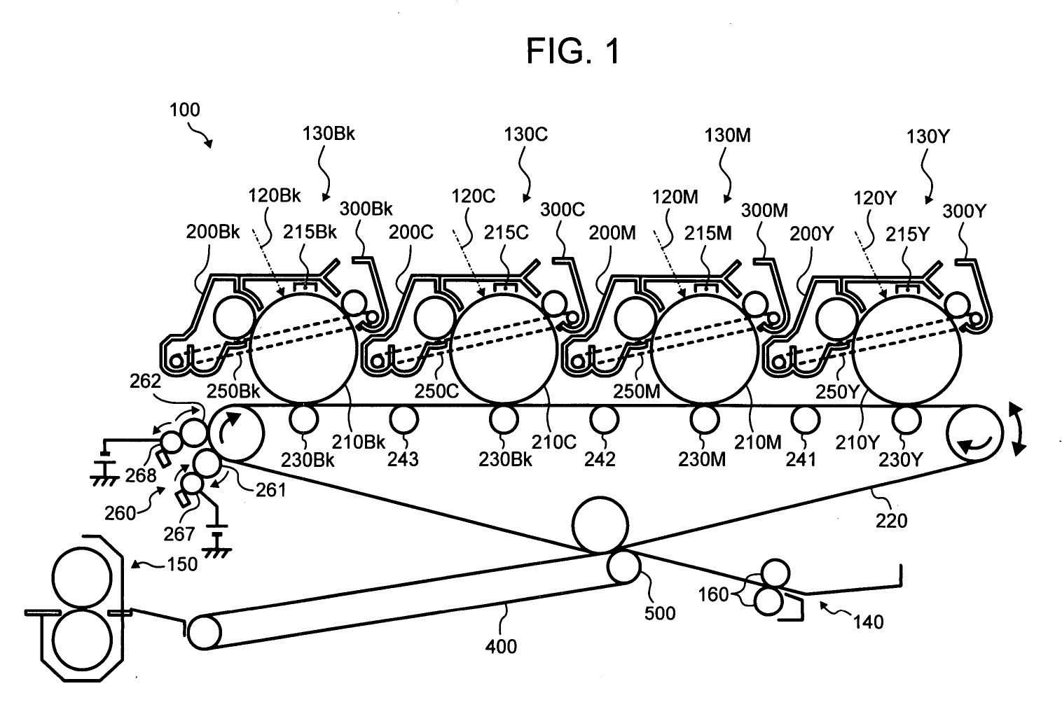

The image forming apparatus of the present invention is described below using an embodiment but is not limited thereto. FIG. 1 is a schematic diagram illustrating the image forming apparatus using a toner and a developer for use in the present invention.

In FIG. 1, a main body 100 mainly includes image writing portions 120Bk, 120C, 120M and 120Y, image forming portions 130Bk, 130C, 130M and 130Y and a paper feeder 140. An image processing portion (not shown) performs image processing based on image signals, converts the image signals into each color signal of black (BK), cyan (C), magenta (M) and yellow (Y) and transmits each color signal to the image writing portions 120Bk, 120C, 120M and 120Y. The image writing portions 120Bk, 120C, 120M and 120Y are, for example, a laser scanning optical system including a laser light source, an optical deflector such as a polygon mirror, a scanning image focus optical system and mirrors (all of which are not shown) that write images on photoreceptors 210Bk, 210C, 210M and 210Y functioning as image bearing members provided in the image forming portions 130Bk, 130C, 130M and 130Y, respectively, through four writing optical routes corresponding to each color signal mentioned above.

The image forming portions 130Bk, 130C, 130M and 130Y include the photoreceptors 210Bk, 210C, 210M and 210Y, respectively. These photoreceptors are typically OPC photoreceptors. Around each photoreceptor 210Bk, 210C, 210M and 210Y, charging devices 215Bk, 215C, 215M and 215Y, irradiation portions of a laser beam from the image writing portions 120Bk, 120C, 120M and 120Y, developing devices 200Bk, 200C, 200M and 200Y for each color, primary transfer devices 230Bk, 230C, 230M and 230Y, cleaning devices 300Bk, 300C, 300M and 300Y and discharging devices (not shown), are provided. The developing devices 200Bk, 200C, 200M and 200Y mentioned above use a double component magnetic brush development system. In addition, an intermediate transfer belt 220 are placed between each photoreceptor 210Bk, 210C, 210M and 210Y and each primary transfer device 230Bk, 230C, 230M and 230Y, respectively. Each color toner image is transferred and overlapped accordingly on the intermediate transfer belt 220 from each photoreceptor. Thus the toner image on each photoreceptor is borne on intermediate transfer belt 220.

Electroconductive rollers 241, 242 and 243 are provided between the primary transfer devices 230Bk, 230C, 230M and 230Y. After a transfer sheet is fed from the paper feeder 140, the transfer sheet is borne on a transfer belt 400 via a pair of registration rollers 160. The toner image on the intermediate transfer belt 220 is transferred to the transfer sheet by a secondary transfer roller 500 at the point where the intermediate transfer belt 220 meets the transfer belt 400. This is how color image formation is performed.

The transfer sheet, after the toner image transferred thereto, is transferred to a fixing device 150 by the transfer belt 400 and the toner image is then fixed to obtain a color image. The toner remaining on the intermediate transfer belt 220 which has not been transferred is removed from the intermediate transfer belt 220 by an intermediate transfer belt cleaning device 260.

Since the polarity of the toner on the intermediate transfer belt 220 before the toner is transferred onto the transfer sheet is negative as developed, a positive bias voltage is applied to the secondary transfer roller 500 to transfer the toner to the transfer sheet. The nip pressure at this point affects the transferability and has a great impact on the fixability. In addition, the toner remaining on the intermediate transfer belt 220 which has not been transferred may be dischargingly charged to the positive side when the transfer sheet detaches from the intermediate transfer belt 220. As a result, the toner remaining on the intermediate transfer belt 220 is charged to zero or to a positive value.

As an example, the thickness of the photoreceptor layer is set to be 30 μm, the beam spot diameter of the optical system is set to be 50×60 μm and the amount of light is set to be 0.47 mW. Further, a voltage Vo at the photoreceptor 210Bk before irradiation, a voltage VL thereat after irradiation and the development bias voltage are, e.g., set to be −700 V, −120 V and −470 V, respectively, meaning that the development process is performed with the development potential of 350 V. The elicited black toner image formed on the photoreceptor 210Bk is processed through transferring (intermediate transfer belt and transfer sheet) and fixing to obtain a complete image. The transfer process is first performed by the primary transfer devices 230Bk, 230C, 230M and 230Y to which a bias is supplied and secondly performed by the separate secondary transfer roller 500 to which a bias is applied. Thus the toner image is transferred to the transfer sheet.

Next, the photoreceptor cleaning device is described in detail. In FIG. 1, each developing device 200Bk, 200C, 200M and 200Y is connected with each cleaning device 300Bk, 300C, 300M and 300Y via each toner transport tube 250Bk, 250C, 250M and 250Y (each shown by dashed lines in FIG. 1), respectively. The toner retrieved by each cleaning device 300Bk, 300C, 300M and 300Y are transported by a screw (not shown) provided inside each toner transport tube 250Bk, 250C, 250M and 250Y to each developing device 200Bk, 200C, 200M and 200Y.

In the background direct transfer system in which the four photoreceptor drums and belt conveyance are combined, the photoreceptors attract paper dust when the photoreceptors directly contact with a transfer paper. Thus, when the toner is retrieved, the toner contains paper dust. This leads to the deterioration of the image quality resulting from, for example, omission of toner at the time of image formation. Therefore, this system is not suitable for a practical use. Further, in a typical system in which one photoreceptor drum and an intermediate transfer device are combined, attachment of paper dust during transfer is prevented by adoption of the intermediate transfer device. However, it is impossible to retrieve the remaining toner on the photoreceptor for a recycle use because it is practically impossible to separate mixed color toner. There is a proposal that the mixed color toner can be used as black toner. However, even when all the colors are mixed, the obtained mixed toner does not show the color of black. In addition, the color changes depending on printing modes. Therefore, toner recycling is impossible in the single photoreceptor structure.

In contrast, in the case of the printer for use in this embodiment, such paper dust attachment hardly occurs because the intermediate transfer belt 220 is used. In addition, the attachment of paper dust to the intermediate transfer belt 220 during transfer to paper can be prevented. Since each photoreceptor 210Bk, 210C, 210M and 210Y uses a different color toner, it is not necessary to attach to and detach from each photoreceptor cleaning device 300BK, 300C, 300M and 300Y from each photoreceptor and thereby toner can securely be retrieved.

The positively-charged toner remaining on the intermediate transfer belt 220 mentioned above is removed by an electroconductive fur brush 262 to which a negative bias is applied. The method of applying a voltage to the electroconductive fur brush 262 is the same as that for an electroconductive fur brush 261 except that the polarity applied is different. The toner remaining which has not been transferred can be substantially removed by the two electroconductive fur brushes 261 and 262. The remaining toner, paper dust, talc, etc., which have not been removed by the electrocondcutive fur brush 262 are negatively biased because of the negative bias of the electrocondcutive fur brush 262.

Since the next primary transfer of black color is a positively-biased transfer, the negatively-biased toner, etc., are attracted to the intermediate transfer belt 220. Therefore, the transfer of the negatively-biased toner, etc., to the photoreceptor for black color can be prevented.

Rollers 267 and 268 are provided in contact with the electroconductive fur brushes 261 and 262. Voltages applied to the rollers 267 and 268 are reverse to those applied to the electroconductive fur brushes 261 and 262 so that the materials attracted to the brushes 261 and 261 can be transferred to the rollers 267 and 268. A blade is provided for each of the rollers 267 and 268 in contact therewith to scrape off the materials on the rollers 267 and 268.

Next, the intermediate transfer belt 220 for use in the image forming apparatus in this embodiment is now described. The intermediate transfer belt is preferably a single resin layer and optionally includes an elastic layer and a surface layer.

Specific examples of the resin materials forming the resin layer 220a mentioned above, and as illustrated in FIG. 5, include polycarbonate; fluorine containing resin such as ethylene-tetrafluoroetylene. (ETFE) and polyvinylidene fluoride (PVDF); styrene-containing resin (monopolymers or copolymers containing styrene or a styrene substitute) such as polystyrene, chloropolystyrene, poly-α-methylstyrene, styrene-butadiene copolymers, styrene-vinyl chloride copolymers, styrene-vinyl acetate copolymers, styrene maleic acid copolymers, styrene acrylate ester copolymers (styrene-metylacrylate copolymers, styrene-etylacrylate copolymers, styrene-butylacrylate copolymers, styrene-octylacrylate copolymers and styrene-phenyl acrylate copolymers), styrene-methacrylate ester copolymers (styrene-methylmethacrylate copolymers, styrene-ethylmethacrylate copolymers, and styrene-phenyl methacrylate copolymers), styrene-α-methyl chloroacrylate copolymers, and styrene-acrylonitrile-acrylate ester copolymers; methyl methacrylate resins; butyl methacrylate resins; ethyl acrylate resins; butyl acrylate resins; modifiedacryl resins (siliconemodified acryl resins, vinylchloride resin modified acryl resins, acryl-urethane resins, etc.); vinyl chloride resins; styrene-vinyl acetate copolymers; vinylchloride-vinyl acetate copolymers; rosin modified maleic acid resin; phenol resins; epoxy resins; polyester resins; polyester polyurethane resins; polyethylene; polypropylene; polybuthadiene; polyvinyidene chloride; ionomer resins; polyurethane resins; silicone resins; ketone resins; ethylene-ethylacrylate copolymers; xylene resins and polyvinyl butyral resins; polyamide resins; and modified polyphenylene oxide resins. These can be used singly or in combination. The resin materials used for the resin layer 220a are not limited thereto.

Specific examples of the resin materials (elastic rubber and elastomers) forming the elastic layer 220b mentioned above, and as illustrated in FIG. 5, include butyl rubber, fluorine containing rubber, acryl rubber, ethylene propylene diene monomer (EPDM) rubber, nitrile rubber (NBR), acrylointrile-butadiene-styrene rubber natural rubber, isoprene rubber, styrene-butadiene rubber, butadiene rubber, ethylene-propylene rubber, ethylene-propylene terpolymers, chloroprene rubber, chlorosulfonated polyethylene, chlorinated polyethylene, urethane rubber, syndiotactic 1,2-polybutadiene, epichlorohydrin containing rubber, silicone rubber, fluorine rubber, polysulfide rubber, polynorbornene rubber, hydrogenated nitrile rubber, and thermoplastic elastomers such as polystyrene containing elastomers, polyolefine containing elastomers, polyvinyl chloride containing elastomers, polyurethane containing elastomers, polyamide containing elastomers, polyurea containing elastomers, polyester containing elastomers and fluorine resin containing elastomers). These can be used singly or in combination. The elastic materials used for the elastic layer 220b are not limited thereto.

In addition, although there is no specific limitation to the kinds of the materials for the surface layer 220c mentioned above, and as illustrated in FIG. 5, materials which can improve the secondary transfer property by reducing the attachment force of the toner to the intermediate transfer belt 220 are preferred. For example, polyurethanes, polyesters, epoxy resins, etc. can be used singly or in combination together with other materials in a manner that the other materials are dispersed. Such other materials are, for example, powder or particles of fluorine resins, fluorine compounds, fluorine carbides, titanium dioxides, and silicon carbide which can reduce the surface energy to improve lubricity. These materials can be used alone or in combination. Further, the same material having different particle diameters can be used together. In addition, when a fluorine containing rubber material is thermally treated, a fluorine rich surface layer having a small surface energy can be formed. Such a material can also be used.

An electroconductive agent is added to the resin layer 220a and the elastic layer mentioned above to control the resistance. There is no specific limit to such electrocondcutive agents. Specific examples of such agents include carbon black, graphite, powder of a metal such as aluminum and nickel, and electroconductive metal oxides such as tin oxides, titanium oxides, antimony oxides, indium oxides, kalium titanate, mixture oxides of antimony oxide-tin oxide (ATO) and mixture oxides of indium oxide and tin oxide (ITO). These electroconductive can be optionally coated with insulative particulates of, for example, barium sulfate, magnesium silicate and calcium carbonate. The electroconductive agents are not limited thereto.

The intermediate transfer belt 220 mentioned above for use in this embodiment has a volume resistance of from 10¹² to 10¹⁴ Ωcm. When the volume resistance of the intermediate transfer belt 220 is too small, the toner on the portion of the belt surface located between the primary transfer point and the secondary transfer point is not held sufficiently, which may lead to toner scattering. In contrast, when the volume resistance of the intermediate transfer belt 220 is too large, discharge is not sufficiently performed by a ground roller. Thereby, charges caused by the secondary transfer are accumulated on the portion of the belt surface located between the secondary transfer point and the primary transfer point. As a result, non-uniform first transfer occurs, causing non-uniform images. To prevent the occurrence of this non-uniform image, a dedicated discharging device is provided, resulting in increase in cost. Therefore, it is preferred that the volume resistance of the intermediate transfer belt 220 is from 10¹² to 10¹⁴ Ωcm.

There are various kinds of methods of manufacturing the intermediate transfer belt 220 such as a centrifugal molding method in which a belt is formed by pouring a material into a rotating cylindrical mold, a spray application method by which a thin surface layer is formed, a dipping method in which a cylindrical mold is dipped into and drawn out of the solution of a material, a cast molding method in which a material is poured into between an inside mold and an outside mold, and a method by which a compound is wound around a cylindrical mold for vulcanization and grinding. The methods of manufacturing the intermediate transfer belt 220 are not limited thereto. In addition, these methods can be used in combination for belt manufacturing.

An example of a cast molding method of manufacturing the intermediate transfer belt 220 is now described as follows:
(1) dip a cylindrical mold into a dispersion solution in which 18 parts by weight of carbon black, 3 parts by weight of a dispersant and 400 parts by weight of toluene based on 100 parts by weight of polyvinylidene fluoride (PVDF) are uniformly dispersed;
(2) gently draw up the cylindrical mold at a pace of 10 mm/sec;
(3) dry the cylindrical mold at room temperature to form a uniform PVDF layer having a thickness of 75 μm;
(4) repeat the procedures of (1) to (3) for the cylindrical mold having the PVDF layer therearound to form the resin layer 220a formed of PVDF having a thickness of 150 μm.
(5) further, dip the cylindrical mold having the resin layer 220a formed of 150 μm PVDF therearound into a dispersion solution in which 100 parts by weight of a polyurethane prepolymer, 3 parts by weight of a curing agent (isocyanate), 20 parts by weight of carbon black, 3 parts by weight of a dispersant and 500 parts by weight of methyl ethyl ketone (MEK) are uniformly dispersed;
(6) draw up the cylindrical mold at the pace of 30 mm/sec;
(7) let the cylindrical mold dry naturally;
(8) repeat the procedures of (5) to (7) to obtain the elastic layer 220b formed of an urethane polymer layer having a desired thickness of 150 μm on the surface of the resin layer 220a;
(9) further dip the cylindrical mold having the resin layer 220a formed of PVDF and the elastic layer 220b formed of urethane prepolymer therearound into a dispersion solution in which 100 parts by weight of polyurethane prepolymer, 3 parts by weight of a curing agent (isocyanate), 50 parts by weight of polytetrafluoroethylene (PTFE) powder particulate, 4 parts by weight of a dispersant and 500 parts by weight of methylethylketone (MEK) are dispersed for forming the surface layer 220c;
(10) draw up the cylindrical mold at the pace of 30 mm/sec;
(11) let the cylindrical mold dry naturally;
(12) repeat the procedures of (9) to (11) to obtain the surface layer 220c formed of urethane polymer having a thickness of 5 μm in which PTFE is uniformly dispersed;
(13) dry the cylindrical mold at room temperature; and
(14) perform cross-linkage for 2 hours at 130° C.

An intermediate transfer belt is thus obtained having a three-layered structure formed of the resin layer 220a having a thickness of 150 μm, the elastic layer 220b having a thickness of 150 μm and the surface layer 220c having a thickness of 5 μm.

To prevent stretch of the intermediate transfer belt 220, there are methods such as the method mentioned above in which the elastic layer 220b is formed on the resin layer 220a functioning as a core with little stretch and a method in which a material which can prevent the stretch is mixed in the core layer. Specific examples of materials which can prevent the stretch of the core layer include natural fiber such as cotton and silk, synthetic fiber such as polyester fiber, nylon fiber, acrylic fiber, polyolefin fiber, polyvinyl alcohol fiber, polyvinyl chloride fiber, polyvinylidene chloride fiber, polyurethane fiber, polyacetal fiber, polyfluoroethylene fiber and phenol fiber, inorganic fiber such as carbon fiber, glass fiber and boron fiber, metal fiber such as iron fiber and copper fiber. Theses can be used alone or in combination to form woven fabric or filament fabric. The materials which can be used to prevent stretch of the belt are not limited thereto.

The filament mentioned above can be twisted using a piece of or multiple pieces thereof. Any twisting method, for example, single twisted yarn, double-folded twisted yarn and multi-folded twisted yarn, can be used. In addition, the fabric of the material selected from the materials mentioned above can be mixed. Or such a filament can be used singly after the filament is electroconductively treated. With regard to the woven fabric, any weaving method such as knitting can be used. Combined woven fabric can also be used. Such fabric can be electroconductively treated.

There is no specific limit to the methods of manufacturing a core layer. For example, there can be used a method in which a die is covered with a woven fabric having a cylindrical form and is further covered with a covering layer, a method in which a woven fabric having a cylindrical form is dipped in a liquid rubber, etc., and covers either side or both sides of the core layer, and a method in which a filament is spirally wound around a die, etc., with an arbitrary pitch and a covering layer is formed thereon.

When the thickness of the elastic layer 220b is too thick, expansion and contraction of the surface becomes large so that cracking easily occurs in the surface depending on the hardness of the elastic layer 220b. In addition, too large an amount of expansion and contraction is not preferred because expansion and contraction of an image also become large. Therefore, the thickness of the elastic layer 220b is preferably thinner than about 1 mm.

The suitable range of the hardness (HS) of the intermediate transfer belt 220 is 10°≦HS≦60° (JISK7215 durometer type A). The optimal hardness of the intermediate transfer belt 220 varies depending on the thickness thereof. In this embodiment, when the hardness thereof is in the range mentioned above, the transfer ratio is improved, meaning that the amount of recycled toner is reduced. Therefore, image deterioration can be further avoided and the quality of an image can be maintained. When the hardness (JIS K 7215 durometer type A) is too small, it is extremely difficult to mold with excellent dimension accuracy. This is because the intermediate transfer belt 220 easily expands and contracts during molding. A soft intermediate transfer belt can be typically obtained by the material containing an oil component. However, there is a drawback in that, when such a soft intermediate transfer layer operates continuously under a high pressure, the oil component exudes.

When the oil component exuded is attached to each photoreceptor 210Bk, 210C, 210M and 210Y contacting the intermediate transfer belt 220, the photoreceptors deteriorate in a manner that the surface thereof is irregular in the transverse direction. Typically the surface layer 220c is provided to improve releasability, but to provide perfect protection effect against the oil exudation, high durability of the surface layer 220c is required so that selecting the materials and securing characteristics are difficult. When the hardness (JIS K7215 durometer type A) is too large, there is an advantage in that the intermediate transfer belt 220 can be accurately molded because of the increase in its hardness. However, the pressure between the intermediate transfer belt 220 and the transfer material decreases. This may result in deterioration of transferability.

In the embodiment mentioned above, the structure of the intermediate transfer belt is described, but an intermediate transfer device having a drum form can also be used. Further, this cleaning system can be applied to the cleaning device for use in cleaning a photoreceptor.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example

The present invention is now specifically described with reference to examples.

First, embodiments in a first case, in which the image forming apparatus and the method using the belt type fixing device without an intermediate transfer device of the present invention, are described.

In examples of the embodiments in the first case of the present invention, the following fixing device and the toner were used.

[Fixing Device]

Fixing Device A

| | |
|---|---|
| The fixing device illustrated in FIG. 2 was set under the following conditions. | |
| The standard fixing temperature was set at 130° C. but | |
| can be changed. | |
| Belt speed | 222 mm/sec |
| Fixing nip width | 10 mm |
| Fixing nip time | 45 ms |
| Fixing roller R1 (opposing rotation body): | |
| Roller outer diameter: | 40 mm |
| (Inside layer (core): stainless core diameter: 24 mm) | |
| (Surface layer: elastic layer made of silicone rubber foam having | |
| a hardness of 30 Hs (spring type hardness) and a thinkness of | |
| 8 mm) | |
| Pressing roller R2: | |
| Roller outer diameter: | 40 mm |
| (Inside layer (core): hollow portion having a diameter of | |
| 37 mm, with a metal core made of iron having a thickness of 1 mm | |
| toward outside, a Si rubber layer having a thickness of 0.5 mm | |
| (rubber hardness: 75 HS) and a surface layer, i.e., a | |
| perfluoroalkoxy (PFA) tube layer having a thickness of 30 μm) | |
| Heating roller R3: | |
| Roller outer diameter: | 30 mm |
| (Core: halogen heater) | |
| (Outside layer: aluminum layer having a thickness of 2 mm) | |
| Fixing belt B: | |
| Belt diameter: | 60 mm |
| Belt width: | 310 mm |
| (Two layered structure: a substrate made of nickel having | |
| a thickness of about 40 μm and a surface layer formed of | |
| silicone rubber having a thickness of about 150 μm with | |
| a surface roughness Rz of 3.3 μm) | |
| Oil application roller R4: | |
| Amount of oil application: | 2 mg/A4 paper |

Fixing Device B

| | |
|---|---|
| The following two changes were | |
| made to the fixing device A. | |
| (1) the amount of oil application: | 0.5 mg/A4 paper |
| (2) the release layer of the fixing | |
| belt was changed to a flourine | |
| containing resin layer having a thickness | |
| of about 50 μm and a surface | |
| roughness of 6.0 μm. | |

Fixing Device C

FIG. 3 is a diagram illustrating an example of the fixing device having a belt induction heating system related to the present invention.

The fixing device illustrated in FIG. 3 includes a heating roller 1 heated by electromagnetic induction of an induction heating device 6, a fixing roller 2 (opposing rotation body) located in parallel to the heating roller 1, an endless heat-resistant belt 3 (medium to heat toner) suspended over the heating roller 1 and the fixing roller 2 and a pressing roller 4 (pressing rotation body) pressed against the fixing roller 2 with the belt 3 therebetween. The belt 3 is driven to rotate in the direction indicated by an arrow A by the rotation of at least one of the heating roller 1 and the fixing roller 2. The pressing roller 4 rotates in the forward direction of that of the belt 3. A temperature sensor 5 is provided in contact with the inside of the belt 3. The temperature sensor 5 detects and feeds back the temperature of the belt 3 to maintain the temperature in a certain range.

The heating roller 1 is made of a magnetic metal, such as iron, cobalt, nickel and their alloy, having a hollow cylindrical form and having an outer diameter of from, for example, 20 to 40 mm and a thickness of from, for example, 0.3 to 1.0 mm to have a low thermal capacity so that the speed of rising temperature of the heating roller 1 is fast.

The fixing roller 2 (opposing rotation body) includes a metal core 2a made of, for example, stainless steel and an elastic member 2b formed of silicone rubber solid or foam having a good heat resistance. The core metal 2a is coated by the elastic member 2b. The fixing roller 2 has a relatively large outer diameter in comparison with that of the heating roller 1 to form a contact portion having a predetermined width between the pressing roller 4 and the fixing roller 2 under the pressure from the pressing roller 4. The elastic member 2b has a thickness of from about 4 to about 6 mm. Having this structure, the fixing roller 2 has a relatively large thermal capacity in comparison with that of the heating roller 1. Therefore, the heating roller 1 is rapidly heated, resulting in shortening of the warm-up time.

The belt 3 suspended over the heating roller 1 and the fixing roller 2 is heated at a contact point W1 between the belt 3 and the heating roller 1 heated by the induction heating device 6. Then the inside of the belt 3 is continuously heated by the rotation of the heating roller 1 and the fixing roller 2. As a result, the whole of the belt 3 is heated.

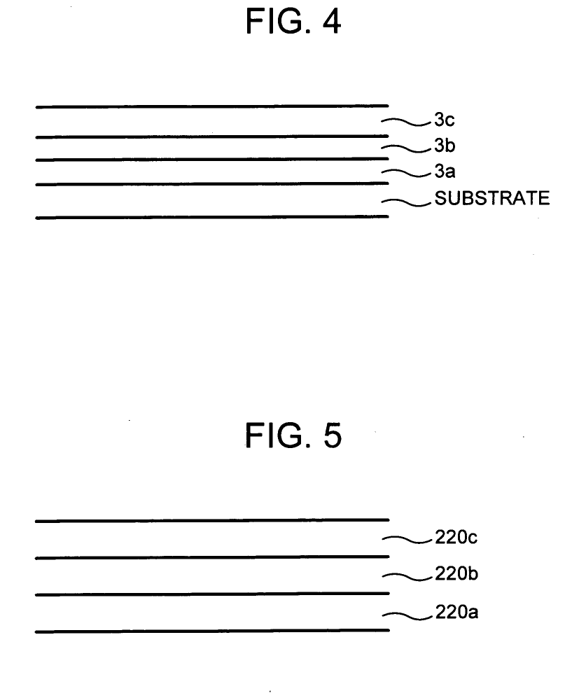

The structure of the belt 3 is as follows as illustrated in FIG. 4:
from its inside to outside, the following 4 layers are provided:
(1) Substrate (a resin layer: e.g., polyimide (PI) resins)
(2) Heat generation layer 3a (electroconductive materials, e.g., Ni, Ag and SUS)
(3) Intermediate layer 3b (for uniform fixing at the elastic layer)
(4) Surface layer 3c (release layer) (fluorine containing resin material, for release effect and oilless fixing)

The surface layer 3c preferably has a thickness of from about 10 to about 300 μm and particularly preferably about 200 μm. In this range, as illustrated in FIG. 3, a toner image T formed on a recording material 11 is fully covered by the belt 3 so that the toner image T can be uniformly heated and fused.

The thickness of the surface layer 3c, i.e., the surface release layer, is at least 10 μm to secure the abrasion-resistance over time property.

In addition, when the thickness of the surface layer 3c is too thick, the thermal capacity of the belt 3 is large so that its warm-up time is long. Further, it is hard to make the temperature of the surface of the belt 3 fall during the toner fixing process. Thereby, the agglomeration effect of the fused toner at the end of the fixing portion is lost. Therefore, the releasablity of the belt 3 deteriorates, resulting in attachment of the toner thereto, i.e., the occurrence of hot offset.

As the base material for the belt 3, a resin layer using a resin having a good heat-resistance property such as fluorine containing resins, polyimide resins, polyamide resins, polyamideimide resins, polyetheretherketone (PEEK) resins, polyethersulfone (PES) resins and polyphenelenesulfide (PPS) resins can be used instead of the heat generation layer 3a made of the metals mentioned above.

The pressing roller 4 includes a core metal 4a made of a metal having a high thermal conductivity such as copper and aluminum and having a cylindrical form and an elastic member 4b provided on the surface of the core metal 4a having a high heat-resistance property and a good toner releasability. The core metal 4a can be made of SUS other than the metals mentioned above.

The pressing roller 4 forms a nip portion N while pressing the fixing roller 2 with the belt 3 between the pressing roller 4 and the fixing roller 2. In this embodiment, the pressing roller 4 is relatively hard in comparison with the fixing roller 2. Therefore, the pressing roller 4 sinks in the fixing roller 2 (and the belt 3). Thereby the recording material 11 is transported along the circumference of the pressing roller 4 so that the recording material 11 easily releases from the surface of the belt 3. The pressing roller 4 has an outer diameter of from about 20 to about 40 mm, which is about the same as that of the fixing roller 2, but its thickness is from about 0.5 to about 2.0 mm, which is relatively thin compared with the fixing roller 2.

The induction heating device 6, which applies heat to the heating roller 1 by electromagnetic induction, includes an exciting coil 7 generating a magnetic filed, and a coil guide board 8 around which the exciting coil 7 is wound. The coil guide board 8 has a semicircular form and is located close to the outer circumference of the heating roller 1. The exciting coil 7 is a coil in which a long exciting coil wire rod is alternatively wound along the coil guide board 8 in the axial direction of the heating roller 1. The oscillating circuit of the exciting coil 7 is connected to the driving power supply (not shown).

Outside the exciting coil 7, an exciting coil core 9 formed of a ferromagnetic material such as ferrite having a semicylindrical form is provided close to the exciting coil 7 while the exciting coil core 9 is fixed by an exciting coil core supporting member 10.

For the structure mentioned above, the following conditions were set as a specific example.

Fixing Roller 2
(Outer diameter: 38 mm (inside layer (core): a stainless core metal having a diameter of 28 mm; outside layer: an elastic layer formed by a silicone rubber foam having a thickness of 5 mm and a rubber hardness of 25 Hs)

Pressing Roller 4
(Outer diameter: 40 mm (inside layer (core): an aluminum core metal having a diameter of 37 mm; toward outside, an iron core metal having a thickness of 1.0 mm; further a Si rubber layer having a thickness of 0.5 mm and a rubber hardness of 60 Hs; and furthermore a surface layer, i.e., a perfluoroalkoxy (PFA) tube layer having a thickness of 30 μm)

Heating Roller 1

(Outer diameter: 30 mm (hollow inside and the outside layer made of a magnetic iron oxide having a thickness of 0.8 mm.) Fixing condition:

| | |
|---|---|
| Belt speed: | 289 mm/sec |
| Nip width: | 13 mm |
| Nip time | 45 ms |

Fixing belt: 4 layered structure from the inside layer to the surface layer:
(Inside layer side) PI (50 μm)+Ni (40 μm)+Si rubber (150 μm)+fluorine resin (20 μm) (Surface side)

[Toner]

| | |
|---|---|
| Composition materials of Toner a | |
| Binder resin | 100 parts by weight |
| (polyol resin: ½ fluxion starting | |
| temperature: 116° C.) | |
| Colorant | |
| Yellow toner: | 5 parts by weight |
| (benzuimidazolone containing yellow dye) | |
| (C.I.Pigment Yellow 180) | |
| Magenta toner: | 4 parts by weight |
| (quinacridone containing magenta dye) | |
| (C.I.Pigment Red 122) | |
| Cyan toner: | 2 parts by weight |
| (copper phthlocyanine blue dye) | |
| (C.I.Pigment Blue 15) | |
| Black toner: | 6 parts by weight |
| (carbon black) | |
| Charge controlling agent: | 2 parts by weight |
| (zinc salt of salicylic acid derivative) | |
| Composition materials of Toner b | |
| Binder resin: | 97 parts by weight |
| (polyester resin: ½ fluxion starting | |
| temperature: 120° C.) | |
| Release agent: | 3 parts by weight |
| (carnauba wax | |
| Colorant and charge control agent: | |
| Same as those for Toner a | |
| Composition materials of Toner c | |
| Binder resin: | 100 parts by weight |
| (polyester resin: ½ fluxion starting | |
| temperature: 104° C.) | |
| Colorant and charge control | |
| agent: Same as those for Toner a | |

With regard to Toners a, b and c, each color toner was fully mixed with a blender and the mixture was fused and kneaded by a two-axis extruder heated to from 100 to 110° C. Subsequent to cooling down, the kneaded resultant was coarsely pulverized by a cutter mill followed by fine pulverization by a fine pulverizer using jet air stream. The resultant was classified by an air classifier to obtain mother colorant particles for each color. The weight average particle diameter of the obtained particles are shown in Table 1.

Composition Materials for Toner d

Same as those of Toner a.
Mother colorant particles having a substantially spherical form by a surfusion system device (manufactured by Hosokawa Micron Corporation, air stream temperature: 270° C. and feed amount: 1 kg/hour). Form factor SF-1 of the mother colorant particles was 114.

Further, 1.5 parts by weight of hydrophobic silica and 1.0 parts by weight of titanium oxide based on 100 parts of Mother colorant particles of Toners a to d were mixed with a HENSCHEL MIXER® and toners for each color of yellow, magenta, cyan and black were obtained.

Preparation of Toner e

(Synthesis of Toner Binder Resin)

(1) The following components were placed in a reacting container equipped with a condenser, a stirrer and a nitrogen introducing tube and reacted for 8 hours at 230° C. under normal pressure.

| | |
|---|---|
| Adduct of bisphenol A with 2 moles | 724 parts |
| of ethylene oxide | |
| Isophthalic acid | 276 parts |
| Dibutyl tin oxide | 2 parts |

(2) The reaction was further performed for 5 hours under a reduced pressure of from 10 to 15 mmHg.

(3) Subsequent to cooling down to 160° C., 32 parts of phthalic anhydride were added thereto and the resulting mixture was allowed to react for 2 hours.

(4) Subsequent to cooling down to 80° C., 188 parts of isophorone diisocyanate was added thereto in ethylacetate and the resulting mixture was allowed to react for 2 hours to obtain prepolymer (1) containing isocyanate.

(5) Next, 267 parts of prepolymer (1) was reacted with 14 parts of isophorone diamine at 50° C. for two hours to obtain a urea modified polyester resin (1) having a weight average molecular weight of 64,000.

Similarly,
(1) 724 parts of an adduct of bisphenol A with 2 moles of ethylene oxide and 276 parts of terephthalic acid were polycondensated at 230° C. under normal pressure for 8 hours.

(2) The reaction was further performed for 5 hours under a reduced pressure of from 10 to 15 mmHg to obtain non-modified polyester resin (a) having a peak molecular weight of 5,000.

(3) 200 parts of urea modified polyester resin (1) and 800 parts of non-modified polyester resin (a) were dissolved and mixed in 2,000 parts of a mixture solvent of ethyl acetate/methyl ethyl ketone (MEK) (1/1) to obtain a solution of ethyl acetate/methyl ethyl ketone of toner binder resin (1).

(4) A portion of the solution was dried under a reduced pressure to isolate the toner binder (1). The toner binder (1) had a Tg of 62° C. and an acid value of 10 mgKOH/g.

(Manufacturing of Toner)

The following components were placed in a beaker and stirred at 60° C. by a TK type HOMOMIXER at 12,000 rpm to be uniformly dissolved and dispersed.

| | |
|---|---|
| Ethyl acetate/methyl ethyl ketone | 240 parts |
| solution of the toner binder (1) | |
| mentioned above | |
| Pentaerythritol tetrabehenate (melting | 20 parts |
| point of 81° C., fusing | |
| viscosity of 25 cps) | |
| Copper phthalocyanine blue dye | 4 parts |

Further, 706 parts of ion exchanged water, 294 parts of 10% hydroxyapatite suspension (SUPERTITE 10 from Nippon Chemical Industrial Co., Ltd) and 0.5 parts of dodecyl benzene sulfonic sodium were added and dissolved in the beaker. The solution was heated to 60° C., and then stirred with a TK HOMOMIXER at 12,000 rpm. Then the toner material liquid prepared above was added thereto. Subsequent to stirring for 10 minutes, the mixture was moved to a flask equipped with a stirrer and a thermometer and heated to 98° C. to partially remove the solvent therein. The mixture solution was cooled down to room temperature and stirred with the TK HOMOMIXER at 12,000 rpm to completely remove the solvent. After filtering, washing and drying, the resultant powder was subject to air separating to obtain mother toner particles. The weight average molecular weight of the mother toner particles was 3.3 μm.

Further, 1.5 parts of a hydrophobic silica and 1.0 parts of a hydrophobic titanium oxide based on 100 parts of the mother toner particles were mixed with a HENSCHEL mixer to obtain Toner e.

A toner was mixed with a carrier in which a silicone resin was coated on the surface of ferrite particles having an average particle diameter of 50 μm with a ratio of the toner to the carrier of 5/100 based on parts by weight by a turbular mixer to obtain a two component developer for yellow, magenta, cyan and black. These developers were set in the developing portion of a photocopier (Ipsio 8200, manufactured by Ricoh Co., Ltd.) and a full color image was obtained on a Gilbert Lancaster Bond paper (cotton paper having a smoothness of 18 sec) or a recycled paper (manufactured by Ricoh Co., Ltd., resource, type A, smoothness of 34 sec) as a transfer material. The transfer materials used are shown in Table 1.

The images produced were solid images or half-tone images having a single color selected from yellow, magenta and cyan, and solid images of a single color selected from intermediate colors of green, blue and red. In this photocopier, the amounts of toner for use in developing solid portions of a single color and half-tone portions of a single color were adjusted to be in the range of from 0.9 to 1.1 mg/cm² and from 0.3 to 0.5 mg/cm², respectively. In addition, the photocopier was remodeled such that the proper fixing device can be replaced with another fixing device. The fixability was evaluated at the lowest allowable fixing temperature. The lowest allowable fixing temperature was determined to be a temperature of the fixing belt below which the remaining ratio of a fixed image density was less than 70% after the fixed image was abraded by a pat.

### Example 1

A fixed image of Toner a was obtained at the standard fixing temperature of 130° C. using the fixing device A. The lowest allowable fixing temperature was 110° C. The 10,000th fixed image obtained at the standard fixing temperature was still vivid and clear without offset. Thereafter, the fixing portion was disassembled and the surface of the belt and oil application roller were checked. Contamination thereon with toner was not observed. The evaluation results are shown in Table 1.

### Example 2

A fixed image of Toner b was obtained at the standard fixing temperature of 130° C. using the fixing device B. The lowest allowable fixing temperature was 115° C. and thereafter the fixing temperature was set back to the standard fixing temperature. The 10,000th fixed image performed at the standard fixing temperature was still vivid and clear without offset as in Example 1. Further, contamination on the surface of the belt and the oil application roller with the toner was not observed. The evaluation results are shown in Table 1.

### Example 3

A fixed image of Toner b was obtained at the standard fixing temperature of 130° C. using the fixing device C. The lowest allowable fixing temperature was 110° C. and the obtained image was vivid and clear. Thereafter the fixing temperature was set back to the standard fixing temperature. The 10,000th fixed image performed at the standard fixing temperature was still vivid and clear without offset as in Example 1. Further, contamination on the surface of the belt and the oil application roller with the toner was not observed. The evaluation results are shown in Table 1.

### Example 4

A fixed image of Toner c was obtained at the standard fixing temperature of 130° C. using the fixing device C while the hardness of the elastic layer of the fixing roller was changed from 25 to 35 Hs, thereby changing the nip time to a value of 36 ms. The lowest allowable fixing temperature was 110° C. and the obtained image was vivid and clear. Thereafter the fixing temperature was set back to the standard fixing temperature. The 10,000th fixed image performed at the standard fixing temperature was still vivid and clear without offset as in Example 1. Further, contamination on the surface of the belt and the oil application roller with the toner was not observed. The evaluation results are shown in Table 1.

### Example 5

A fixed image of Toner d was obtained at the standard fixing temperature of 130° C. using the fixing device A. The lowest allowable fixing temperature was 105° C. and the obtained image was vivid and clear. Thereafter the fixing temperature was set back to the standard fixing temperature. The 10,000th fixed image performed at the standard fixing temperature was still vivid and clear without off set as in Example 1. Further, contamination on the surface of the belt and the oil application roller with the toner was not observed. The evaluation results are shown in Table 1.

### Example 6

A fixed image of Toner e was obtained at the standard fixing temperature of 130° C. using the fixing device A. The lowest allowable fixing temperature was 105° C. and the obtained image was vivid and clear. Thereafter the fixing temperature was set back to the standard fixing temperature. The 10,000th fixed image performed at the standard fixing temperature was still vivid and clear without offset as in Example 1. Further, contamination on the surface of the belt and the oil application roller with the toner was not observed. The evaluation results are shown in Table 1.

### Example 7

A fixed image of Toner a was obtained at the standard fixing temperature of 130° C. using the fixing device A while the hardness of the elastic layer of the fixing roller was changed from 30 to 25 Hs and the hardness of the elastic layer of the pressing roller was changed from 75 to 55 Hs. Thereby, the nip time was changed from 45 to 36 ms. The 10,000th fixed image performed at the standard fixing temperature was still vivid and clear without offset as in Example 1. Further, contamination on the surface of the belt and the oil application roller with the toner was not observed. The evaluation results are shown in Table 1.

### Example 8

A fixed image of Toner c was obtained at the standard fixing temperature of 130° C. using the fixing device C while the hardness of the elastic layer of the fixing roller was changed from 25 to 60 Hs and the hardness of the elastic layer of the pressing roller was changed from 60 to 25 Hs. As a result, the nip time remained 45 ms. The 10,000th fixed image performed at the standard fixing temperature was still vivid and clear without offset as in Example 1. Further, contamination on the surface of the belt and the oil application roller with the toner was not observed. The evaluation results are shown in Table 1.

### Comparative Example 1

A fixed image of Toner a was obtained at the standard fixing temperature of 130° C. using the fixing device A in the same manner as described in Example 1 except that the nip timer was changed from 45 to 30 ms due to changes made to the pressing conditions for the fixing roller and the pressing roller. The lowest allowable fixing temperature was up to 160° C. The evaluation results are shown in Table 1.

### Comparative Example 2

A fixed image of Toner a was obtained at the standard fixing temperature of 130° C. using the fixing device A in the same manner as described in Example 1 except that the nip timer was changed from 45 to 75 ms due to changes made to the pressing conditions for the fixing roller and the pressing roller. The lowest allowable fixing temperature was 105° C. When the 10,000th fixed image performed at the standard fixing temperature was observed as in Example 1, contamination was observed in the image due to offset corresponding to the solid image. The evaluation results are shown in Table 1.

### Comparative Example 3

The same evaluation was made for Toner a and the Fixing device A in the same manner as in Examples 1 except that the weight average particle diameter of Toner a used in Example 1 was changed to 6.5 μm.

### Comparative Example 4

A fixed image of Toner a was obtained with the fixing temperature set to the standard fixing temperature (130° C.) in the same manner as in Example 1 except that the elastic layer of the fixing roller was changed to silicone rubber having a hardness of 50 Hs and the elastic layer of the pressing roller was changed to silicone rubber having a hardness of 50 Hs. The lowest allowable fixing temperature was 105° C. For the 10,000th fixed image obtained by the same performance at the standard fixing temperature as in Example 1, offset phenomenon occurred in the solid portion and the half portion of the fixed image. The evaluation results are shown in Table 1.

TABLE 1

| | Fixing device | | | | | | | | | | |
|---|---|---|---|---|---|---|---|---|---|---|---|
| | | | Hardness | | | | | | | | |
| | | | of | | | | | | | | |
| | | | elastic | | | | | | | | |
| | | | layer | | Fixing | | | WAPD | Lowest | | |
| | | Nip | (HS) | | belt | | | of | fixing | Offset | |
| | | Time | Fixing | Pressing | Surface | Transfer | | toner | temp | (10000^{th} | |
| | Device | (ms) | roller | roller | material | medium | Toner | (μm) | (° C.) | print) | Evaluation |
| E1 | A | 45 | 30 | 75 | SR | 1 | a | 4.2 | 110 | No | G |
| E2 | B | 45 | 30 | 75 | SR | 1 | b | 3.2 | 115 | No | G |
| E3 | C | 45 | 25 | 60 | F | 1 | b | 3.3 | 110 | No | G |
| E4 | C | 36 | 35 | 60 | F | 2 | c | 2.7 | 105 | No | G |
| E5 | A | 45 | 30 | 75 | SR | 2 | d | 3.9 | 105 | No | G |
| E6 | A | 45 | 30 | 75 | SR | 2 | e | 3.3 | 105 | No | G |
| E7 | A | 65 | 25 | 55 | SR | 1 | a | 4.2 | 100 | No | G |
| E8 | C | 45 | 60 | 25 | F | 1 | c | 4.2 | 120 | No | G |
| CE1 | A | 30 | 30 | 75 | SR | 1 | a | 4.2 | 160 | No | B |
| CE2 | A | 75 | 30 | 75 | SR | 1 | a | 4.2 | 105 | Yes | B |
| CE3 | A | 45 | 30 | 75 | SR | 1 | a | 6.5 | 135 | Yes | B |
| CE4 | A | 45 | 50 | 50 | F | 1 | a | 4.2 | 115 | Yes | B |

The toner evaluated was a cyan toner.

In Table 1, “WAPD” represents “weight average particle diameter” and “E” and “CE” represent “Example” and “Comparative Example”, respectively. Also “SR” and “F” represent “silicone rubber” and “fluorine containing resin”, respectively. Further, “G” and “B” represent “good” and “bad”, respectively. Furthermore, 1 and 2 for the transfer medium represent “Gilbert Lancaster Bond paper and recycle paper (manufactured by Ricoh Co., Ltd., resource type A), respectively.

Next, embodiments in the second case, in which the full-color image forming apparatus and method use a fixing belt and an intermediate transfer device of the present invention, are described below.

In Examples in the embodiment of the second case of the present invention, the following fixing device and toner were used.

(Description of Fixing Device)

Fixing Device D

The Fixing device D was the same as the Fixing device A except for the following changes:

| | |
|---|---|
| Belt speed: | 150 mm/sec |
| Fixing nip pressure: | variable pressure from both rollers |
| | (the values for Examples are shown in Table 2.) |
| Fixing nip width: | 8 mm |
| Fixing nip time: | 53.3 ms |

Fixing Device E

The fixing device E was the same as the Fixing device D except for the following two changes.
(1) the amount of oil application: 0.5 mg/A4 paper
(2) the release layer (surface layer) of the fixing belt:
   Fluorine resin layer having a thickness of about 50 μm and a roughness of 6.0 μm
      Fixing Device F

The Fixing device F was the same as the Fixing device C except for the following change.
Nip pressure: Variable pressure from both rollers
   (the values for Examples are shown in Table 2.)
      (Toner)

The toners were prepared by the same manner as described in Toners a to e.

Their form factors SF-1 were as follows and their weight average particle diameter (μm) are shown in Table 2.
Toner a: 160
Toner b: 165
Toner c: 163
Toner d: 112
Toner e: 110
   (Evaluation of Fixability)

A toner was mixed with a carrier in which a silicone resin was coated on the surface of ferrite particles having an average particle diameter of 50 μm with a ratio of the toner to the carrier of 5/100 based on parts by weight by a turbular mixer to obtain a two component developer for yellow, magenta, cyan and black. These developers were set in the developing portion of the image forming apparatus illustrated in FIG. 1 and a full color image was obtained on a Gilbert Lancaster Bond paper (cotton paper having a smoothness of 18 sec) or a recycle paper (manufactured by Ricoh Co., Ltd., resource, type A, smoothness of 34 sec) as a transfer material. The transfer materials used are shown in Table 1.

The images produced were solid images or half-tone images having a single color selected from yellow, magenta and cyan, and solid images of a single color selected from intermediate colors of green, blue and red. In this photocopier, the amounts of toner for use in developing solid portions of a single color and half-tone portions of a single color were adjusted to be from 0.9 to 1.1 mg/cm2 and from 0.3 to 0.5 mg/cm2, respectively. In addition, the photocopier was remodeled such that the proper fixing device can be replaced with another fixing device. The lowest allowable fixing temperature was used to evaluate the fixability. The lowest allowable fixing temperature was determined to be a temperature of the fixing belt below which the remaining ratio of a fixed image density was less than 70% after the fixed image was abraded by a pat.

### Example 9

A fixed image of Toner a was obtained by using the image forming apparatus illustrated in FIG. 1 with the nip pressure of the secondary transfer set at 5.5 N/cm2 and the Fixing device D with its standard fixing temperature set at 130° C. The resulting lowest allowable fixing temperature was 110° C. The 10,000th fixed image obtained at the standard fixing temperature was still vivid and clear without offset. Thereafter, the fixing portion was disassembled and the surface of the belt and oil application pad were checked. Traces of contamination with toner were not observed for these. The evaluation results are shown in Table 2.

### Example 10

A fixed image of Toner b was obtained by using the image forming apparatus illustrated in FIG. 1 with the nip pressure of the secondary transfer set at 4.5 N/cm2 and the Fixing device E with its standard fixing temperature set at 130° C. The resulting lowest allowable fixing temperature was 115° C. Thereafter the lowest allowable fixing temperature was set back to the standard fixing temperature. The 10,000th fixed image performed at the standard fixing temperature was still vivid and clear without offset as in Example 9. Contamination on the surface of the belt with toner was not observed. The evaluation results are shown in Table 2.

### Example 11

A fixed image of Toner b was obtained by using the image forming apparatus illustrated in FIG. 1 with the nip pressure of the secondary transfer set at 7.0 N/cm2 and the Fixing device F with its standard fixing temperature set at 130° C. The fixed image obtained at the lowest allowable fixing temperature of 110° C. was vivid and clear. Thereafter the lowest allowable fixing temperature was set back to the standard fixing temperature. The 10,000th fixed image performed at the standard fixing temperature was still vivid and clear without offset as in Example 9. Contamination on the surface of the belt with toner was not observed. The evaluation results are shown in Table 2.

### Example 12

A fixed image of Toner c was obtained by using the image forming apparatus illustrated in FIG. 1 with the nip pressure of the secondary transfer set at 9.5 N/cm2 and the Fixing device F with its standard fixing temperature set at 130° C. The fixed image obtained at the lowest allowable fixing temperature of 105° C. was vivid and clear. Thereafter the lowest allowable fixing temperature was set back to the standard fixing temperature. The 10,000th fixed image performed at the standard fixing temperature was still vivid and clear without offset as in Example 9. Contamination on the surface of the belt and the oil application roller with the toner was not observed. The evaluation results are shown in Table 2.

### Example 13

A fixed image of Toner d was obtained by using the image forming apparatus illustrated in FIG. 1 with the nip pressure of the secondary transfer set at 2.5 N/cm2 and the Fixing device D with its standard fixing temperature set at 130° C. The fixed image obtained at the lowest allowable fixing temperature of 105° C. was vivid and clear. Thereafter the lowest allowable fixing temperature was set back to the standard fixing temperature. The 10,000th fixed image performed at the standard fixing temperature was still vivid and clear without offset as in Example 9. Contamination on the surface of the belt and the oil application roller with the toner was not observed. The evaluation results are shown in Table 2.

### Example 14

A fixed image of Toner e was obtained by using the image forming apparatus illustrated in FIG. 1 with the nip pressure of the secondary transfer set at 5.5 N/cm2 and the Fixing device D with its standard fixing temperature set at 130° C. The fixed image obtained at the lowest allowable fixing temperature of 105° C. was vivid and clear. Thereafter the lowest allowable fixing temperature was set back to the standard fixing temperature. The 10,000th fixed image performed at the standard fixing temperature was still vivid and clear without offset as in Example 9. Contamination on the surface of the belt with toner and the oil application roller was not observed. The evaluation results are shown in Table 2.

### Example 15

A fixed image of Toner a was obtained by using the image forming apparatus illustrated in FIG. 1 with the nip pressure of the secondary transfer set at 5.5 N/cm2 and the Fixing device D with its standard fixing temperature set at 130° C. The fixed image obtained at the lowest allowable fixing temperature of 115° C. was vivid and clear. Thereafter the lowest allowable fixing temperature was set back to the standard fixing temperature. The 10,000th fixed image performed at the standard fixing temperature was still vivid and clear without offset as in Example 9. Contamination on the surface of the belt and the oil application roller with the toner was not observed. The evaluation results are shown in Table 2.

### Example 16

A fixed image of Toner c was obtained by using the image forming apparatus illustrated in FIG. 1 with the nip pressure of the secondary transfer set at 5.5 N/cm2 and the Fixing device F with its standard fixing temperature set at 130° C. The fixed image obtained at the lowest allowable fixing temperature of 105° C. was vivid and clear. Thereafter the lowest allowable fixing temperature was set back to the standard fixing temperature. The 10,000th fixed image performed at the standard fixing temperature was still vivid and clear without offset as in Example 9. Contamination on the surface of the belt and the oil application roller with the toner was not observed. The evaluation results are shown in Table 2.

### Comparative Example 5

The same evaluation as in Example 9 was made for toner f, which was the same as Toner a used in Example 9 except that the weight average particle diameter was changed to 5.8 μm according to changes in pulverization and classification conditions. The form factor SF-1 of Toner f was 168. The evaluation results are shown in Table 2.

### Comparative Example 6

The same evaluation as in Example 9 was made for toner g, which was the same as Toner a used in Example 9 except that the weight average particle diameter was changed to 1.8 μm according to changes in pulverization and classification conditions. The form factor SF-1 of Toner g was 150. The evaluation results are shown in Table 2.

TABLE 2

| | Secondary | Fixing device | | | | | | | | |
|---|---|---|---|---|---|---|---|---|---|---|
| | transfer | | | Fixing | | | WAPD | Lowest | | |
| | Nip | | Nip | bele | | | of | fixing | Offset | |
| | pressure | | pressure | Surface | Transfer | | toner | temp | (10000th | |
| | (N/cm2) | Device | (N/cm2) | material | medium | Toner | (μm) | (° C.) | print) | Evaluation |
| E9 | 5.5 | A | 30.6 | SR | 1 | a | 3.5 | 110 | No | G |
| E10 | 4.5 | B | 33.3 | SR | 1 | b | 4.5 | 115 | No | G |
| E11 | 7 | C | 32.8 | F | 1 | b | 4.5 | 110 | No | G |
| E12 | 9.2 | C | 11.2 | F | 2 | c | 2.5 | 105 | No | G |
| E13 | 2.5 | A | 29.5 | SR | 1 | d | 3.8 | 105 | No | G |
| E14 | 5.5 | A | 29.5 | SR | 2 | e | 4.0 | 105 | No | G |
| E15 | 5.5 | A | 11.8 | SR | 1 | a | 3.5 | 115 | No | G |
| E16 | 5.5 | C | 47.9 | F | 1 | c | 2.5 | 105 | No | G |
| CE5 | 5.5 | A | 30.6 | SR | 1 | F | 5.8 | 150 | No | B |
| CE5 | 5.5 | A | 30.6 | SR | 1 | g | 1.8 | 140 | No | B |

The toner evaluated was a cyan toner.

In Table 2, “WAPD” represents “weight average particle diameter” and “E” and “CE” represent “Example” and “Comparative Example”, respectively. Also “SR” and “F” represent “silicone rubber” and “fluorine containing resin”, respectively. Further, “G” and “B” represent “good” and “bad”, respectively. Furthermore, 1 and 2 for transfer medium represent “Gilbert Lancaster Bond paper and recycle paper (manufactured by Ricoh Co., Ltd., resource type A), respectively.

This document claims priority and contains subject matter related to Japanese Patent Applications Nos. 2004-172364 and 2004-209838, filed on Jun. 10, 2004, and Jul. 16, 2004, respectively, the entire contents of each of which are incorporated herein by reference.

Having now fully described the invention, it will be apparent to one of ordinary skill in the art that many changes and modifications can be made thereto without departing from the spirit and scope of the invention as set forth therein.

1. An image forming apparatus, comprising:
an image bearing member;
a charging device configured to charge the image bearing member;
an irradiating device configured to irradiate the image bearing member to form a latent electrostatic image thereon;
a developing device configured to develop the latent electrostatic image on the image bearing member into a toner image with a toner;
a cleaning device configured to remove residual toner remaining on the image bearing member;
a transfer device configured to transfer the toner image to a recording material; and
a fixing device configured to fix the toner image on the recording material, comprising:
an endless belt comprising an elastic layer on a surface thereof;
a plurality of rotation bodies located inside the endless belt, at least one of which is a heating roller;
a pressing rotation body located outside the endless belt and configured to form a nip portion with the endless belt while sandwiching the endless belt with one of the plurality of the rotation bodies which is placed opposite to the pressing rotation body to fix the toner image on the recording material upon application of heat,
wherein a nipping time is from 35 to 70 ms, at least one of the pressing rotation body and the rotation body located opposite thereto has an elastic layer having a rubber hardness of from 20 to 40 Hs, and the toner has a weight average particle diameter of from 2 to 5 μm.

2. The image forming apparatus according to claim 1, wherein a surface of the pressing rotation body is covered with a material comprising at least one of a fluorine resin and a silicone resin.

3. The image forming apparatus according to claim 1, wherein, both the pressing rotation body and the rotation body located opposite to the pressing body comprise an elastic layer, and the elastic layer of the rotation body located opposite to the pressing body has a relatively small rubber hardness in comparison with that of the pressing rotation body.

4. The image forming apparatus according to claim 1, wherein the toner has a form factor SF-1 of from 110 to 150.

5. The image forming apparatus according to claim 1, wherein the fixing device further comprises an electromagnetic generation device and the heating roller comprises a magnetic metal and is heated by electromagnetic induction of the electromagnetic induction generation device.

6. The image forming apparatus according to claim 5, wherein the electromagnetic induction generation device is provided outside the heating roller with the endless belt therebetween and the heating roller is different from the rotation body located opposite to the pressing body.

7. The image forming apparatus according to claim 1, wherein the pressing rotation body comprises a heat source.

8. The image forming apparatus according to claim 1, wherein particulates having a number average particle diameter of from 0.04 to 0.30 μm are attached to a surface of the toner.

9. The image forming apparatus according to claim 1, wherein the toner further comprises a release agent and a content thereof is 3 to 10 weight % based on a weight of the toner.

10. The image forming apparatus according to claim 1, wherein the toner is manufactured in an aqueous medium.

11. The image forming apparatus according to claim 1, wherein the image bearing member is an amorphous silicon photoreceptor.

12. The image forming apparatus according to claim 1, wherein, when the latent electrostatic image is developed, an alternative electric field is applied thereto.

13. The image forming apparatus according to claim 1, wherein the charging device comprises a charging member and charges the image bearing member by applying a voltage to the charging portion while the charging member is in contact with the image bearing member.

14. The image forming apparatus according to claim 1, wherein the transfer device comprises an intermediate transfer device configured to form full color images, to which the toner image is primarily transferred from the image bearing member and from which the transferred image is secondarily transferred to the recording material with a nip pressure of from 2 to 10 N/cm2 and a nip pressure at the fixing device is from 10 to 50 N/cm2.

15. The image forming apparatus according to claim 14, wherein processes for forming the full color images are performed using a tandem system.

16. The image forming apparatus according to claim 14, wherein the intermediate transfer device comprises a single layer comprising a resin.

17. A method of forming an image, comprising:
charging an image bearing member by a charging device;
irradiating the image bearing member by an irradiating device to form a latent electrostatic image thereon;
developing the latent electrostatic image on the image bearing member with a toner by a developing device into a toner image removing residual toner remaining on the image bearing member by a cleaning device;
transferring the toner image to a recording material by a transfer device; and
fixing the toner image on the recording material by a fixing device, comprising:
an endless belt comprising an elastic layer on a surface thereof;
a plurality of rotation bodies located inside the endless belt, at least one of which is a heating roller;
a pressing rotation body located outside the endless belt and configured to form a nip portion with the endless belt while sandwiching the endless belt with one of the plurality of the rotation bodies which is placed opposite to the pressing rotation body to fix the toner image on the recording material upon application of heat,
wherein a nipping time is from 35 to 70 ms, at least one of the pressing rotation body and the rotation body located opposite thereto has an elastic layer having a rubber hardness of from 20 to 40 Hs, and the toner has a weight average particle diameter of from 2 to 5 μm.

18. A toner, comprising:
toner particles having a weight average particle diameter of from 2 to 5 μm,
wherein the toner is used in an image forming apparatus comprising an image bearing member, a charging device configured to charge the image bearing member, an irradiating device configured to irradiate the image bearing member to form a latent electrostatic image thereon, a developing device configured to develop the latent electrostatic image on the image bearing member with the toner into a toner image, a cleaning device configured to remove residual toner remaining on the image bearing member, a transfer device configured to transfer the toner image to a recording material, and a fixing device configured to fix the toner image on the recording material, the fixing device comprising an endless belt comprising an elastic layer on a surface thereof, a plurality of rotation bodies located inside the endless belt, at least one of which is a heating roller, a pressing rotation body located outside the endless belt and configured to form a nip portion with the endless belt while sandwiching the endless belt with one of the plurality of the rotation bodies which is placed opposite to the pressing rotation body to fix the toner image on the recording material upon application of heat, wherein a nipping time is from 35 to 70 ms, at least one of the pressing rotation body and the rotation body located opposite thereto has an elastic layer having a rubber hardness of from 20 to 40 Hs.

19. The toner according to claim 18, wherein the toner has a form factor SF-1 of from 110 to 150.

20. The toner according to claim 18, wherein particulates having a number average particle diameter of from 0.04 to 0.30 μm are attached to a surface of the toner particle.

21. The toner according to claim 18, further comprising a release agent, a content of which is from 3 to 10 weight % based on a content of the toner.

22. The toner according to claim 18, wherein the toner is manufactured in an aqueous medium.

23. A process cartridge, comprising:
an image bearing member;
at least one device selected from the group consisting of a charging device to charge the image bearing member, a developing device and a cleaning device, which is integrally supported with the image bearing member,
wherein the process cartridge is detachably attached to an image forming apparatus comprising a charging device configured to charge the image bearing member, an irradiating device configured to irradiate the image bearing member to form a latent electrostatic image thereon, a developing device configured to develop the latent electrostatic image on the image bearing member with a toner into a toner image, a cleaning device configured to remove residual toner remaining on the image bearing member, a transfer device configured to transfer the toner image to a recording material, and a fixing device configured to fix the toner image on the recording material, the fixing device comprising an endless belt comprising an elastic layer on a surface thereof, a plurality of rotation bodies located inside the endless belt, at least one of which is a heating roller, a pressing rotation body located outside the endless belt and configured to form a nip portion with the endless belt while sandwiching the endless belt with one of the plurality of the rotation bodies which is placed opposite to the pressing rotation body to fix the toner image on the recording material upon application of heat, and wherein a nipping time is from 35 to 70 ms, at least one of the pressing rotation body and the rotation body located opposite thereto has an elastic layer having a rubber hardness of from 20 to 40 Hs, and the toner has a weight average particle diameter of from 2 to 5 μm.

24. An image forming apparatus, comprising:
means for bearing an image;
means for charging the means for bearing an image;
means for irradiating the means for bearing an image to form a latent electrostatic image thereon;
means for developing the latent electrostatic image on the means for bearing an image into a toner image with a toner;
means for removing residual toner remaining on the means for bearing an image;
means for transferring the toner image to a recording material; and
means for fixing the toner image on the recording material, comprising:
an endless belt comprising an elastic layer on a surface thereof;
a plurality of rotation bodies located inside the endless belt, at least one of which is a heating roller;
a pressing rotation body located outside the endless belt and configured to form a nip portion with the endless belt while sandwiching the endless belt with one of the plurality of the rotation bodies which is placed opposite to the pressing rotation body to fix the toner image on the recording material upon application of heat,
wherein a nipping time is from 35 to 70 ms, at least one of the pressing rotation body and the rotation body located opposite thereto has an elastic layer having a rubber hardness of from 20 to 40 Hs, and the toner has a weight average particle diameter of from 2 to 5 μm.
